(19) United States
(12) Patent Application Publication
(10) Pub. No.: US 2025/0291046 A1
(43) Pub. Date: Sep. 18, 2025

(54) NON-LINEAR FREQUENCY-MODULATED CONTINUOUS WAVE (FMCW)-BASED RF SENSING

(71) Applicant: QUALCOMM Incorporated, San Diego, CA (US)

(72) Inventors: Weimin DUAN, San Diego, CA (US); Kangqi LIU, San Diego, CA (US); Danlu ZHANG, San Diego, CA (US)

(21) Appl. No.: 18/588,382

(22) Filed: Feb. 27, 2024

(51) Int. Cl. G01S 13/58; G01S 19/13; H04L 5/00

(52) U.S. Cl. CPC G01S 13/584; G01S 19/13; H04L 5/001; H04L 5/0094

(57) ABSTRACT

In some implementations, a radio frequency (RF) sensing node may receive a non-linear frequency-modulated (NLFM) configuration from a configuring node of a wireless network, where the NLFM configuration is indicative of a set of one or more parameters of a non-linear function describing time-varying frequency characteristics of an NLFM signal to be used by the sensing node for RF sensing. In addition, the device may perform an RF sensing function with the sensing node in accordance with the NLFM configuration.

### BACKGROUND

### 1. Field of Disclosure

The present disclosure relates generally to the field of radio frequency (RF) sensing, and more specifically to RF sensing in a wireless network.

### 2. Description of Related Art

The performance of RF sensing by wireless devices can have a wide range of consumer, industrial, commercial, and other applications. RF sensing can be used to determine the presence of a target object, determine the location of the target object, and/or track the movement of the target object over time. Cellular networks (e.g., fifth-generation (5G) new radio (NR) networks) and other types of wireless networks may be capable of performing RF sensing using base stations, user equipments (UEs), and/or other wireless devices communicatively coupled with the cellular network as “sensing nodes.” To perform RF sensing, these sensing nodes can transmit and receive RF signals, including frequency-modulated continuous wave (FMCW) signals.

### BRIEF SUMMARY

An example method at a sensing node of non-linear frequency-modulated (NLFM) radio frequency (RF) sensing, according to this disclosure, may include receiving an NLFM configuration at a sensing node from a configuring node of a wireless network, where the NLFM configuration is indicative of a set of one or more parameters of a non-linear function describing time-varying frequency characteristics of an NLFM signal to be used by the sensing node for RF sensing. The method may also include performing an RF sensing function with the sensing node in accordance with the NLFM configuration.

An example method at a configuring node of providing a non-linear frequency-modulated (NLFM) configuration for radio frequency (RF) sensing, according to this disclosure, may include determining, with the configuring node of a wireless network, an NLFM configuration for a sensing node, where the NLFM configuration is indicative of a set of one or more parameters of a non-linear function describing time-varying frequency characteristics of an NLFM signal to be used by the sensing node for RF sensing. The method may also include sending the NLFM configuration from the configuring node to the sensing node to enable the sensing node to perform an RF sensing function in accordance with the NLFM configuration.

An example sensing node, according to this disclosure, may include one or more transceivers, one or more memories, and one or more processors communicatively coupled with the one or more transceivers and the one or more memories. The one or more processors may be configured to receive, via the one or more transceivers, an NLFM configuration at the sensing node from a configuring node of a wireless network, where the NLFM configuration is indicative of a set of one or more parameters of a non-linear function describing time-varying frequency characteristics of an NLFM signal to be used by the sensing node for RF sensing. The one or more processors may be configured to perform an RF sensing function with the one or more transceivers in accordance with the NLFM configuration.

An example configuring node, according to this disclosure, may include one or more transceivers, one or more memories, and one or more processors communicatively coupled with the one or more transceivers and the one or more memories. The one or more processors may be configured to determine an NLFM configuration for a sensing node, where the NLFM configuration is indicative of a set of one or more parameters of a non-linear function describing time-varying frequency characteristics of an NLFM signal to be used by the sensing node for RF sensing. The one or more processors may be configured to send the NLFM configuration via the one or more transceivers to the sensing node to enable the sensing node to perform an RF sensing function in accordance with the NLFM configuration.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is an illustration of a positioning/sensing system that can use the techniques provided herein for slope scrambling for frequency-modulated continuous wave (FMCW)-based radio frequency (RF) sensing, according to an embodiment.

FIG. 2 is a diagram of a fifth-generation (5G) new radio (NR) positioning/sensing system, according to an embodiment.

FIG. 3 is a diagram showing an example of a frame structure for NR and associated terminology.

FIG. 4 is a diagram showing example combination (comb) structures, illustrating how RF signals may utilize different sets of resource elements, according to some embodiments.

FIG. 5 is a diagram showing an example of an RF sensing system, according to an embodiment.

FIG. 6 is an illustration of graphs that show how a nonlinear frequency modulated (NLFM) signal may be capable of providing dynamic range, according to some embodiments.

FIG. 7 is a graph that represents degrees of Legendre Polynomials (LPs) in frequency over time, which may be used in some embodiments.

FIG. 8 is an illustration of two graphs that show example NLFM signals that may be used in some embodiments.

FIG. 9 is a graph illustrating how NLFM signals may be multiplexed, according to some embodiments.

FIG. 10 is a message flow diagram of a process by which a configuring node may configure one or more sensing nodes to perform RF sensing using an NLFM signal, according to some embodiments.

FIG. 11 is a flow diagram of a method at a sensing node of NLFM RF sensing, according to an embodiment.

FIG. 12 is a flow diagram of a method of providing an NLFM configuration for RF sensing, according to an embodiment.

FIG. 13 is a block diagram of an embodiment of a mobile sensing node.

FIG. 14 is a block diagram of an embodiment of a stationary sensing node.

FIG. 15 is a block diagram of an embodiment of a computer system.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3, etc., or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c). Drawings may be simplified for discussion purposes and may not reflect certain features of embodiments (e.g., sizes/dimensions, components, etc.) used in real-world applications.

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

As used herein, the terms “RF sensing,” “passive RF sensing,” and variants refer to a process by which one or more objects (which also may be referred to as “targets”) are detected using RF signals transmitted by a transmitting device and, after reflecting from the object(s), received by a receiving device. In a monostatic configuration, the transmitting and receiving devices are the same device. In a bistatic configuration, one device transmits RF signals, and another device receives reflections of the RF signals from one or more objects. In multi-static configuration, one or more receiving devices are separate from one or more transmitting devices. As used herein, the term “static” in the terms “monostatic,” “bistatic,” and “multistatic” (or “multi-static”) are meant to conform with historical literature on RF sensing but are not limited to “static” or stationary sensing nodes. As described herein, in some embodiments, sensing nodes may be mobile. As described herein, devices performing RF sensing may be referred to as “RF sensing nodes” or simply “sensing nodes.” In a bistatic or multi-static configuration, transmitting devices may be referred to as “transmitting nodes,” “Tx sensing nodes,” or “Tx nodes,” and receiving devices may be referred to as “receiving nodes,” “Rx sensing nodes,” or “Rx nodes.” A sensing node may be referred to as either or both in a monostatic configuration. As described hereafter in more detail, a receiving device can make measurements of these reflected RF signals to determine one or more characteristics of one or more objects, such as location, range, angle, direction, orientation, Doppler, velocity, etc. According to some embodiments, RF sensing may be “passive” in that no RF signals need to be transmitted by the receiving device or one or more objects for the one or more objects to be detected.

Additionally, unless otherwise specified, references to “reference signals” and the like may be used to refer to signals used for positioning of a user equipment (UE), sensing of active and/or passive objects by one or more sensing nodes, or a combination thereof. As described in more detail herein, such signals may comprise any of a variety of signal types. This may include but is not limited to, a positioning reference signal (PRS), sounding reference signal (SRS), synchronization signal block (SSB), channel start information reference signal (CSI-RS), or any combination thereof.

Techniques provided herein may apply to “mmWave” technologies, which typically operate at 57-71 GHz, but may include frequencies ranging from 30-300 GHz. This includes, for example, frequencies utilized by the 802.11ad Wi-Fi standard (operating at 60 GHz). That said, some embodiments may utilize RF sensing with frequencies outside this range. For example, in some embodiments, 5G NR frequency bands (e.g., 28 GHZ) may be used. Because RF sensing may be performed in the same bands as communication, hardware may be utilized for both communication and RF sensing. For example, one or more of the components of an RF sensing system as described herein may be included in a wireless modem (e.g., Wi-Fi or NR modem), a UE (e.g., an extended device), or the like. Additionally, techniques may apply to RF signals comprising any of a variety of pulse types, including compressed pulses (e.g., comprising Chirp, Golay, Barker, Ipatov, or m sequences) may be utilized. That said, embodiments are not limited to such frequencies and/or pulse types. Additionally, because the RF sensing system may be capable of sending RF signals for communication (e.g., using 802.11 or NR wireless technology), embodiments may leverage channel estimation and/or other communication-related functions for providing RF sensing functionality as described herein. Accordingly, the pulses may be the same as those used in at least some aspects.

As noted, RF sensing may be performed by wireless devices, or sensing nodes, and can have a wide range of consumer, industrial, commercial, and other applications. RF sensing may utilize one or more sensing nodes and may be coordinated by a wireless network to detect and/or track or target objects. Candidate signals for performing RF sensing include frequency-modulated continuous wave (FMCW) and linear frequency modulation (LFM) signals. Although these signals can be particularly simple to implement, they have their drawbacks. For example, they are particularly vulnerable to inter-node interference, they create sidelobes that can limit their capabilities with respect to multiplexing, and may not have enough dynamic range for some use cases.

Embodiments described herein address these and other issues by utilizing nonlinear FMCW signals, referred to herein as “nonlinear frequency-modulated (NLFM) signals.” Various aspects relate generally to the field of RF-based sensing in a wireless network. Some aspects more specifically relate to providing an NLFM configuration to a sensing node to enable RF sensing that is more compatible with orthogonal frequency division multiplexing (OFDM) communication schemes used in cellular networks. Some examples include a sensing node, such as a user equipment (UE) or base station receiving an NLFM configuration from a configuring node of a wireless network, such as a server, in which the NLFM configuration is indicative of a set of one or more parameters of a non-linear function describing time-varying frequency characteristics of an NLFM signal to be used by the sensing node for RF sensing. According to some embodiments, these one or more parameters may include an order of Legendre Polynomials (LPs) of the non-linear function and a coefficient of the LPs. The sensing node may then perform an RF sensing function (e.g., transmitting and/or receiving the NLFM signal) in accordance with the NLFM configuration.

Particular aspects of the subject matter described in this disclosure can be implemented to realize one or more of the following potential advantages. In some examples, by utilizing an NLFM signal, embodiments may enable compatibility with existing OFDM communication schemes used in cellular networks and boost multiplexing capability for future 6G cellular networks. In some examples, piecewise FMCW waveforms may be appended to the NLFM signal in a manner that avoids frequency jumps in the transmission, allowing a larger number of devices (including low-cost implementations) to transmit and/or receive the NLFM signal. These and other advantages will be apparent to persons of ordinary skill in light of the disclosed embodiments detailed hereafter. A discussion of embodiments is provided after a brief discussion of relevant technology and context/background in which embodiments may be used.

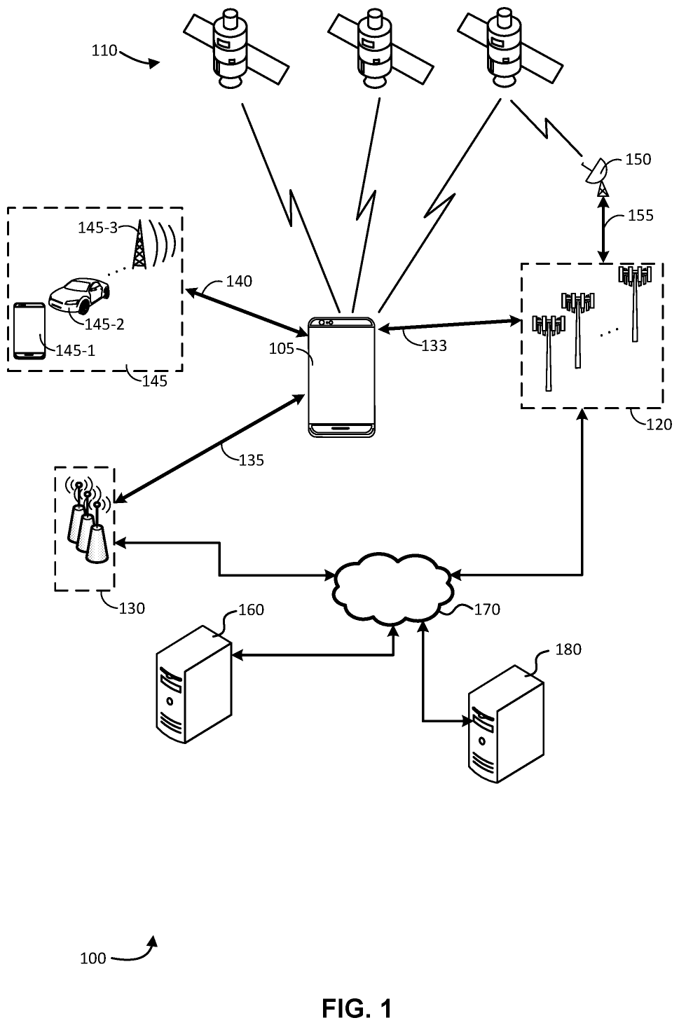

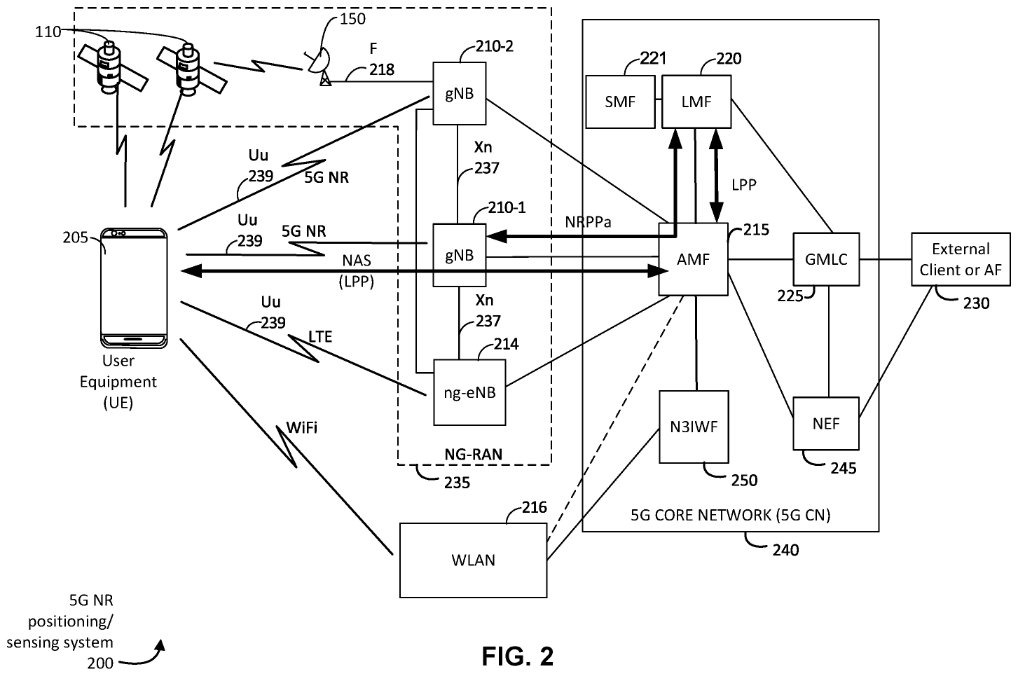

FIG. 1 is a simplified illustration of a positioning/sensing system 100, which may be implemented in conjunction with and/or as part of a wireless communication system (e.g., a cellular communication network) which a mobile device 105, location/sensing server 160, and/or other components of the positioning/sensing system 100 can use the techniques provided herein for using NLFM signals for RF sensing, according to an embodiment. The techniques described herein may be implemented by one or more components of the positioning/sensing system 100, however, the techniques described herein are not limited to such components and may be implemented in other types of systems (not shown). The positioning/sensing system 100 can include a mobile device 105; one or more satellites 110 (also referred to as space vehicles (SVs)) for a Global Navigation Satellite System (GNSS) (such as the Global Positioning System (GPS), GLONASS, Galileo or Beidou) and/or NTN functionality; base stations 120; access points (APs) 130; location/sensing server 160; network 170; and external client 180. Generally put, the positioning/sensing system 100 can estimate the location of the mobile device 105 based on RF signals received by and/or sent from the mobile device 105 and known locations of other components (e.g., GNSS satellites 110, base stations 120, APs 130) transmitting and/or receiving the RF signals. Additionally or alternatively, wireless devices such as the mobile device 105, base stations 120, and satellites 110 (and/or other NTN platforms, which may be implemented on airplanes, drones, balloons, etc.) can be utilized to perform positioning (e.g., of one or more wireless devices) and/or perform RF sensing (e.g., of one or more objects by using RF signals transmitted by one or more wireless devices). Additional details regarding particular location estimation/sensing techniques are discussed with regard to FIG. 2.

It should be noted that FIG. 1 provides only a generalized illustration of various components, any or all of which may be utilized as appropriate, and each of which may be duplicated, as necessary. Specifically, although only one mobile device 105 is illustrated, it will be understood that many UEs (e.g., hundreds, thousands, millions, etc.) may utilize the positioning/sensing system 100. Similarly, the positioning/sensing system 100 may include a larger or smaller number of base stations 120 and/or APs 130 than illustrated in FIG. 1. The illustrated connections that connect the various components in the positioning/sensing system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location/sensing server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G, and NR are wireless technologies defined, or being defined, by the 3rd Generation Partnership Project (3GPP). In an LTE, 5G, or other cellular network, mobile device 105 may be referred to as a user equipment (UE). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUS), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, mobile device 105 can send and receive information with network-connected devices, such as location/sensing server 160, by accessing the network 170 via a base station 120 using a first communication link 133. Additionally or alternatively, because APs 130 also may be communicatively coupled with the network 170, mobile device 105 may communicate with network-connected and Internet-connected devices, including location/sensing server 160, using a second communication link 135, or via one or more other mobile devices 145. As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). According to aspects of applicable 5G cellular standards, a base station 120 (e.g., gNB) may be capable of transmitting different “beams” in different directions and performing “beam sweeping” in which a signal is transmitted in different beams, along different directions (e.g., one after the other). The term “base station” used herein may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As noted, satellites 110 may be used to implement NTN functionality, extending communication, positioning, and potentially other functionality (e.g., RF sensing) of a terrestrial network. As such, one or more satellites may be communicatively linked to one or more NTN gateways 150 (also known as “gateways,” “earth stations,” or “ground stations”). The NTN gateways 150 may be communicatively linked with base stations 120 via link 155. In some embodiments, NTN gateways 150 may function as DUs of a base station 120, as described previously. Not only can this enable the mobile device 105 to communicate with the network 170 via satellites 110, but this can also enable network-based positioning, RF sensing, etc.

Satellites 110 may be utilized in one or more way. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the mobile device 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120 and may be coordinated by a network function server 160, which may operate as a location server. In some embodiments, satellites 110 used for NTN-based positioning may be different than those used for GNSS-based positioning. In some embodiments NTN nodes may include non-terrestrial vehicles such as airplanes, balloons, drones, etc., which may be in addition or as an alternative to NTN satellites. NTN satellites 110 and/or other NTN platforms may be further leveraged to perform RF sensing. As described in more detail hereafter, satellites may use a JCS symbol in an Orthogonal Frequency-Division Multiplexing (OFDM) waveform to allow both RF sensing and/or positioning, and communication.

As used herein, the term “cell” may generically refer to a logical communication entity used for communication with a base station 120 and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location/sensing server 160 may comprise a server and/or other computing device configured to determine an estimated location of mobile device 105 and/or provide data (e.g., “assistance data”) to mobile device 105 to facilitate location measurement and/or location determination by mobile device 105. According to some embodiments, location/sensing server 160 may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in location/sensing server 160. In some embodiments, the location/sensing server 160 may comprise, a Discovered SLP (D-SLP) or an Emergency SLP (E-SLP). The location/sensing server 160 may also comprise an Enhanced Serving Mobile Location Center (E-SMLC) that supports location of mobile device 105 using a control plane (CP) location solution for LTE radio access by mobile device 105. The location/sensing server 160 may further comprise a Location Management Function (LMF) that supports location of mobile device 105 using a control plane (CP) location solution for NR or LTE radio access by mobile device 105.

In a CP location solution, signaling to control and manage the location of mobile device 105 may be exchanged between elements of network 170 and with mobile device 105 using existing network interfaces and protocols and as signaling from the perspective of network 170. In a UP location solution, signaling to control and manage the location of mobile device 105 may be exchanged between location/sensing server 160 and mobile device 105 as data (e.g. data transported using the Internet Protocol (IP) and/or Transmission Control Protocol (TCP)) from the perspective of network 170.

As previously noted (and discussed in more detail below), the estimated location of mobile device 105 may be based on measurements of RF signals sent from and/or received by the mobile device 105. In particular, these measurements can provide information regarding the relative distance and/or angle of the mobile device 105 from one or more components in the positioning/sensing system 100 (e.g., satellites 110, APs 130, base stations 120). The estimated location of the mobile device 105 can be estimated geometrically (e.g., using multiangulation and/or multilateration), based on the distance (range) and/or angle measurements, along with known position of the one or more components.

Additionally or alternatively, the location/sensing server 160, may function as a sensing server. A sensing server can be used to coordinate and/or assist in the coordination of sensing of one or more objects (also referred to herein as “targets”) by one or more wireless devices in the positioning/sensing system 100. This can include the mobile device 105, base stations 120, APs 130, other mobile devices 145, satellites 110, or any combination thereof. Wireless devices capable of performing RF sensing may be referred to herein as “sensing nodes.” To perform RF sensing, a sensing server may coordinate sensing sessions in which one or more RF sensing nodes may perform RF sensing by transmitting RF signals (e.g., reference signals (RSs)), and measuring reflected signals, or “echoes,” comprising reflections of the transmitted RF signals off of one or more objects/targets. Reflected signals and object/target detection may be determined, for example, from channel state information (CSI) received at a receiving device. Sensing may comprise (i) monostatic sensing using a single device as a transmitter (of RF signals) and receiver (of reflected signals); (ii) bistatic sensing using a first device as a transmitter and a second device as a receiver; or (iii) multi-static sensing using a plurality of transmitters and/or a plurality of receivers. To facilitate sensing (e.g., in a sensing session among one or more sensing nodes), a sensing server may provide data (e.g., “assistance data”) to the sensing nodes to facilitate RS transmission and/or measurement, object/target detection, or any combination thereof. Such data may include an RS configuration indicating which resources (e.g., time and/or frequency resources) may be used (e.g., in a sensing session) to transmit RS for RF sensing. According to some embodiments, a sensing server may comprise a Sensing Management Function (SMF or SnMF).

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the mobile device 105, or a combination thereof. Wireless signals from mobile devices 145 used for positioning of the mobile device 105 may comprise RF signals using, for example, Bluetooth® (including Bluetooth Low Energy (BLE)), IEEE 802.11x (e.g., Wi-Fi®), Ultra-Wideband (UWB), IEEE 802.15x, or a combination thereof. Mobile devices 145 may additionally or alternatively use non-RF wireless signals for positioning of the mobile device 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular mobile device 105, the mobile device 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and mobile device 105 may comprise sidelink and/or similar Device-to-Device (D2D) communication technologies. Sidelink, which is defined by 3GPP, is a form of D2D communication under the cellular-based LTE and NR standards.

According to some embodiments, such as when the mobile device 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The mobile device 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the mobile device 105 and may be used to determine the position of the mobile device 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the mobile device 105, according to some embodiments.

An estimated location of mobile device 105 can be used in a variety of applications—e.g. to assist direction finding or navigation for a user of mobile device 105 or to assist another user (e.g. associated with external client 180) to locate mobile device 105. A “location” is also referred to herein as a “location estimate,” “estimated location,” “location,” “position,” “position estimate,” “position fix,” “estimated position,” “location fix” or “fix.” The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, east or west and possibly above or below some other known fixed location (including, e.g., the location of a base station 120 or AP 130) or some other location such as a location for mobile device 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which mobile device 105 is expected to be located with some level of confidence (e.g. 95% confidence).

The external client 180 may be a web server or remote application that may have some association with mobile device 105 (e.g. may be accessed by a user of mobile device 105) or may be a server, application, or computer system providing a location service to some other user or users which may include obtaining and providing the location of mobile device 105 (e.g. to enable a service such as friend or relative finder, or child or pet location). Additionally or alternatively, the external client 180 may obtain and provide the location of mobile device 105 to an emergency services provider, government agency, etc.

As previously noted, the example positioning/sensing system 100 can be implemented using a wireless communication network, such as an LTE-based or 5G NR-based network, or a future 6G network. FIG. 2 shows a diagram of a 5G NR positioning/sensing system 200, illustrating an embodiment of a positioning/sensing system (e.g., positioning/sensing system 100) implemented in 5G NR. The 5G NR positioning/sensing system 200 may be configured to enable wireless communication, determine the location of a UE 205 (which may correspond to the mobile device 105 of FIG. 1), perform RF sensing, or a combination thereof, by using access nodes, which may include NR NodeB (gNB) 210-1 and 210-2 (collectively and generically referred to herein as gNBs 210), ng-eNB 214, and/or WLAN 216 to implement one or more positioning methods. These access nodes can use RF signaling to enable the communication, implement one or more positioning methods, and/or implement RF sensing. The gNBs 210 and/or the ng-eNB 214 may correspond with base stations 120 of FIG. 1, and the WLAN 216 may correspond with one or more access points 130 of FIG. 1. Optionally, the 5G NR positioning/sensing system 200 additionally may be configured to determine the location of a UE 205 by using an LMF 220 (which may correspond with location/sensing server 160) to implement the one or more positioning methods. The SMF 221 may coordinate RF sensing by the 5G NR positioning/sensing system 200. Here, the 5G NR positioning/sensing system 200 comprises a UE 205, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network. Additional components of the 5G NR positioning/sensing system 200 are described below. The 5G NR positioning/sensing system 200 may include additional or alternative components.

The 5G NR positioning/sensing system 200 may further utilize information from satellites 110. As previously indicated, satellites 110 may comprise GNSS satellites from a GNSS system like Global Positioning/sensing system (GPS) or similar system (e.g. GLONASS, Galileo, Beidou, Indian Regional Navigational Satellite System (IRNSS)). Additionally or alternatively, satellites 110 may comprise NTN satellites. NTN satellites may be in low earth orbit (LEO), medium earth orbit (MEO), geostationary earth orbit (GEO) or some other type of orbit. NTN satellites may be communicatively coupled with the LMF 220 and may operatively function as a TRP (or TP) in the NG-RAN 235. As such, satellites 110 may be in communication with one or more gNBs 210 via one or more NTN gateways 150. According to some embodiments, an NTN gateway 150 may operate as a DU of a gNB 210, in which case communications between NTN gateway 150 and CU of the gNB 210 may occur over an F interface 218 between DU and CU.

It should be noted that FIG. 2 provides only a generalized illustration of various components, any or all of which may be utilized as appropriate, and each of which may be duplicated or omitted, as necessary. Specifically, although only one UE 205 is illustrated, it will be understood that many UEs (e.g., hundreds, thousands, millions, etc.) may utilize the 5G NR positioning/sensing system 200. Similarly, the 5G NR positioning/sensing system 200 may include a larger (or smaller) number of satellites 110, gNBs 210, ng-eNBs 214, Wireless Local Area Networks (WLANs) 216, Access and mobility Management Functions (AMF) s 215, external clients 230, and/or other components. The illustrated connections that connect the various components in the 5G NR positioning/sensing system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 205 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 205 may correspond to a cellphone, smartphone, laptop, tablet, personal data assistant (PDA), navigation device, Internet of Things (IoT) device, or some other portable or moveable device. Typically, though not necessarily, the UE 205 may support wireless communication using one or more Radio Access Technologies (RATs) such as using GSM, CDMA, W-CDMA, LTE, High-Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 205 may also support wireless communication using a WLAN 216 which (like the one or more RATs, and as previously noted with respect to FIG. 1) may connect to other networks, such as the Internet. The use of one or more of these RATs may allow the UE 205 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 205 (e.g., via the GMLC 225). The external client 230 of FIG. 2 may correspond to external client 180 of FIG. 1, as implemented in or communicatively coupled with a 5G NR network.

The UE 205 may include a single entity or may include multiple entities, such as in a personal area network where a user may employ audio, video and/or data I/O devices, and/or body sensors and a separate wireline or wireless modem. An estimate of a location of the UE 205 may be referred to as a location, location estimate, location fix, fix, position, position estimate, or position fix, and may be geodetic, thus providing location coordinates for the UE 205 (e.g., latitude and longitude), which may or may not include an altitude component (e.g., height above sea level, height above or depth below ground level, floor level or basement level). Alternatively, a location of the UE 205 may be expressed as a civic location (e.g., as a postal address or the designation of some point or small area in a building such as a particular room or floor). A location of the UE 205 may also be expressed as an area or volume (defined either geodetically or in civic form) within which the UE 205 is expected to be located with some probability or confidence level (e.g., 67%, 95%, etc.). A location of the UE 205 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 205 via wireless communication between the UE 205 and one or more of the gNBs 210, which may provide wireless communications access to the 5G CN 240 on behalf of the UE 205 using 5G NR. The wireless interface between base stations (gNBs 210 and/or ng-eNB 214) and the UE 205 may be referred to as a Uu interface 239. 5G NR radio access may also be referred to as NR radio access or as 5G radio access. In FIG. 2, the serving gNB for UE 205 is assumed to be gNB 210-1, although other gNBs (e.g. gNB 210-2) may act as a serving gNB if UE 205 moves to another location or may act as a secondary gNB to provide additional throughput and bandwidth to UE 205.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 205. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 205 but may not receive signals from UE 205 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 205. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning/sensing system 200, such as the LMF 220 and AMF 215.

5G NR positioning/sensing system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 205 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 205 to other elements in 5G CN 240 and/or may support interworking of one or more protocols used by WLAN 216 and UE 205 to one or more protocols used by other elements of 5G CN 240 such as AMF 215. For example, N3IWF 250 may support IPSec tunnel establishment with UE 205, termination of IKEv2/IPSec protocols with UE 205, termination of N2 and N3 interfaces to 5G CN 240 for control plane and user plane, respectively, relaying of uplink (UL) and downlink (DL) control plane Non-Access Stratum (NAS) signaling between UE 205 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 205 and the AMF 215. As noted, this can include gNBs 210, ng-eNB 214, WLAN 216, and/or other types of cellular base stations, and may also include NTN satellites 110. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214, WLAN 216, or NTN satellite 110.

In some embodiments, an access node, such as a gNB 210, ng-eNB 214, WLAN 216, or NTN satellite 110, or a combination thereof, (alone or in combination with other components of the 5G NR positioning/sensing system 200), may be configured to, in response to receiving a request for location information from the LMF 220, obtain location measurements of uplink (UL) signals received from the UE 205) and/or obtain downlink (DL) location measurements from the UE 205 that were obtained by UE 205 for DL signals received by UE 205 from one or more access nodes. As noted, while FIG. 2 depicts access nodes (gNB 210, ng-eNB 214, WLAN 216, and NTN satellite 110) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 205, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 205 may be applicable to such other networks.

The gNBs 210 and ng-eNB 214 can communicate with an AMF 215, which, for positioning functionality, communicates with an LMF 220. The AMF 215 may support mobility of the UE 205, including cell change and handover of UE 205 from an access node (e.g., gNB 210, ng-eNB 214, WLAN 216, or NTN satellite 110) of a first RAT to an access node of a second RAT. The AMF 215 may also participate in supporting a signaling connection to the UE 205 and possibly data and voice bearers for the UE 205. The LMF 220 may support positioning of the UE 205 using a CP location solution when UE 205 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 205, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 205's location) may be performed at the UE 205 (e.g., by measuring downlink PRS (DL-PRS) signals transmitted by wireless nodes such gNB 210, ng-eNB 214, WLAN 216, or NTN satellite 110, and/or using assistance data provided to the UE 205, e.g., by LMF 220).

The Gateway Mobile Location Center (GMLC) 225 may support a location request for the UE 205 received from an external client 230 and may forward such a location request to the AMF 215 for forwarding by the AMF 215 to the LMF 220. A location response from the LMF 220 (e.g., containing a location estimate for the UE 205) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 205 to the external client 230, which may then be referred to as an Access Function (AF) and may enable the secure provision of information from the external client 230 to 5GCN 240. NEF 245 may be connected to AMF 215 and/or to GMLC 225 for the purposes of obtaining a location (e.g. a civic location) of UE 205 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 205 may communicate using an LTE Positioning Protocol (LPP) as defined in 3GPP TS 37.355. Here, LPP messages may be transferred between the UE 205 and the LMF 220 via the AMF 215 and a serving gNB 210-1 or serving ng-eNB 214 for UE 205. For example, LPP messages may be transferred between the LMF 220 and the AMF 215 using messages for service-based operations (e.g., based on the Hypertext Transfer Protocol (HTTP)) and may be transferred between the AMF 215 and the UE 205 using a 5G NAS protocol. The LPP protocol may be used to support positioning of UE 205 using UE assisted and/or UE-based position methods such as A-GNSS, RTK, TDOA, multi-cell RTT, AoD, and/or ECID. The NRPPa protocol may be used to support positioning of UE 205 using network-based position methods such as ECID, AoA, uplink TDOA (UL-TDOA) and/or may be used by LMF 220 to obtain location-related information from gNBs 210 and/or ng-eNB 214, such as parameters defining DL-PRS transmission from gNBs 210 and/or ng-eNB 214.

In the case of UE 205 access to WLAN 216, LMF 220 may use NRPPa and/or LPP to obtain a location of UE 205 in a similar manner to that just described for UE 205 access to a gNB 210 or ng-eNB 214. Thus, NRPPa messages may be transferred between a WLAN 216 and the LMF 220, via the AMF 215 and N3IWF 250 to support network-based positioning of UE 205 and/or transfer of other location information from WLAN 216 to LMF 220. Alternatively, NRPPa messages may be transferred between N3IWF 250 and the LMF 220, via the AMF 215, to support network-based positioning of UE 205 based on location-related information and/or location measurements known to or accessible to N3IWF 250 and transferred from N3IWF 250 to LMF 220 using NRPPa. Similarly, LPP and/or LPP messages may be transferred between the UE 205 and the LMF 220 via the AMF 215, N3IWF 250, and serving WLAN 216 for UE 205 to support UE-assisted or UE-based positioning of UE 205 by LMF 220.

In a 5G NR positioning/sensing system 200, positioning and sensing methods can be categorized as being “UE assisted” or “UE based.” This may depend on where the request for determining the position of the UE 205 originated. If, for example, the request originated at the UE (e.g., from an application, or “app,” executed by the UE), the positioning method may be categorized as being UE based. If, on the other hand, the request originates from an external client 230, LMF 220, or other device or service within the 5G network, the positioning method may be categorized as being UE assisted (or “network-based”).

With a UE-assisted position method, UE 205 may obtain location measurements and send the measurements to a location server (e.g., LMF 220) for computation of a location estimate for UE 205. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), RSTD, Time of Arrival (TOA), AoA, Receive Time-Transmission Time Difference (Rx-Tx), Differential AoA (DAOA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 205 if the positions of the other UEs are known. The location measurements may also or instead include measurements for RAT-independent positioning methods such as GNSS (e.g., GNSS pseudorange, GNSS code phase, and/or GNSS carrier phase for GNSS satellites), WLAN, etc.

With a UE-based position method, UE 205 may obtain location measurements (e.g., which may be the same as or similar to location measurements for a UE-assisted position method) and may further compute a location of UE 205 (e.g., with the help of assistance data received from a location server such as LMF 220, an SLP, or broadcast by gNBs 210, ng-eNB 214, or WLAN 216).

With a network-based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 205, and/or may receive measurements obtained by UE 205 or by an AP in WLAN 216 in the case of N3IWF 250, and may send the measurements to a location server (e.g., LMF 220) for computation of a location estimate for UE 205.

Positioning of the UE 205 also may be categorized as UL, DL, or DL-UL based, depending on the types of signals used for positioning. If, for example, positioning is based solely on signals received at the UE 205 (e.g., from a base station or other UE), the positioning may be categorized as DL based. On the other hand, if positioning is based solely on signals transmitted by the UE 205 (which may be received by a base station or other UE, for example), the positioning may be categorized as UL based. Positioning that is DL-UL based includes positioning, such as RTT-based positioning, which is based on signals that are both transmitted and received by the UE 205. Sidelink (SL)-assisted positioning comprises signals communicated between the UE 205 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

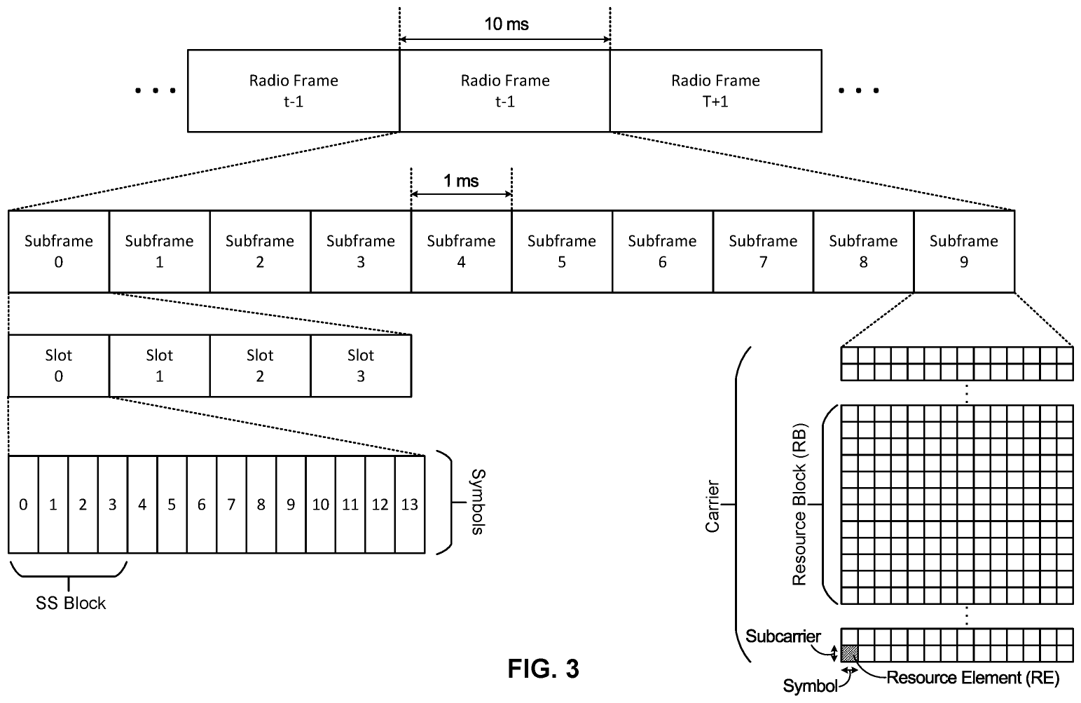

FIG. 3 is a diagram showing an example of a frame structure for NR and associated terminology, which can serve as the basis for physical layer communication between the UE 105 and base stations/TRPs. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices. A mini slot may comprise a sub slot structure (e.g., 2, 3, or 3 symbols). Additionally shown in FIG. 3 is the complete Orthogonal Frequency-Division Multiplexing (OFDM) of a subframe, showing how a subframe can be divided across both time and frequency into a plurality of Resource Blocks (RBs). A single RB can comprise a grid of Resource Elements (REs) spanning 14 symbols and 12 subcarriers.

Each symbol in a slot may indicate a link direction (e.g., downlink (DL), uplink (UL), or flexible) or data transmission, and the link direction for each subframe may be dynamically switched. The link directions may be based on the slot format. Each slot may include DL/UL data as well as DL/UL control information. In NR, a synchronization signal (SS) block is transmitted. The SS block includes a primary SS (PSS), a secondary SS (SSS), and a two-symbol Physical Broadcast Channel (PBCH). The SS block can be transmitted in a fixed slot location, such as the symbols 0-3 as shown in FIG. 3. The PSS and SSS may be used by UEs for cell search and acquisition. The PSS may provide half-frame timing, the SS may provide the cyclic prefix (CP) length and frame timing. The PSS and SSS may provide the cell identity. The PBCH carries some basic system information, such as downlink system bandwidth, timing information within the radio frame, SS burst set periodicity, system frame number, etc.

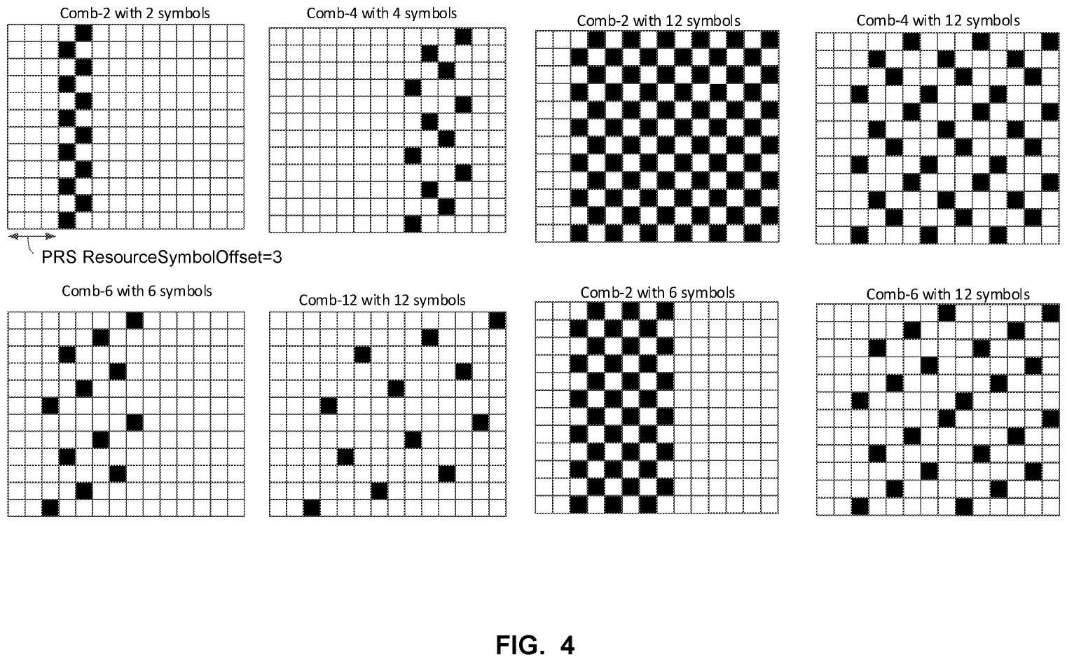

A collection of REs may be used for the transmission of positioning and/or RF sensing signals. The collection of REs can span multiple subcarriers and/or RBs in the frequency domain and one or more symbols within a slot in the time domain. The transmission of positioning and/or RF sensing signal within a given RB has a particular combination, or “comb,” size. (Comb size also may be referred to as the “comb density.”). Examples of different comb sizes using different numbers of symbols are provided in FIG. 4.

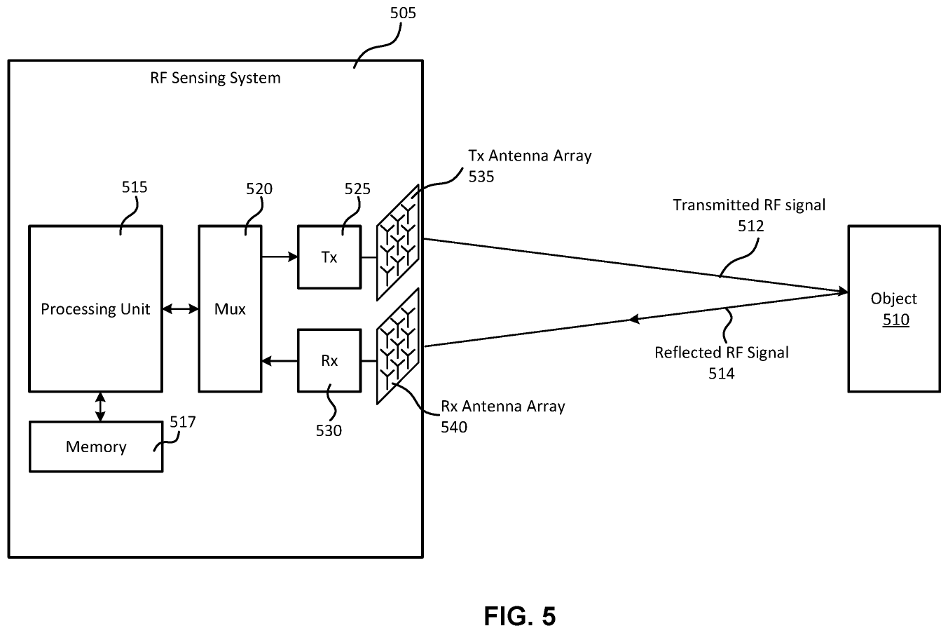

The principles described above with respect to positioning may be generally extended to RF sensing. That is, RF sensing may be UE-based (e.g., originated from the UE) and/or UE assisted (e.g., originated from a non-UE entity), and may involve UL signals, DL signals, or both. However, RF sensing may differ from positioning in various ways. For example, as previously noted and described in more detail below, RF sensing may involve the use of specific RF sensing signals. Further, RF sensing may be performed in a monostatic, bistatic, or multi-static manner, as described above, where RF sensing nodes comprise a UE (e.g., UE 205) and/or one or more access nodes (e.g., gNBs 210, ng-eNB 214, WLAN 216, NTN satellites 110, or any combination thereof). Various aspects of RF sensing are described below in more detail with respect to FIG. 5.

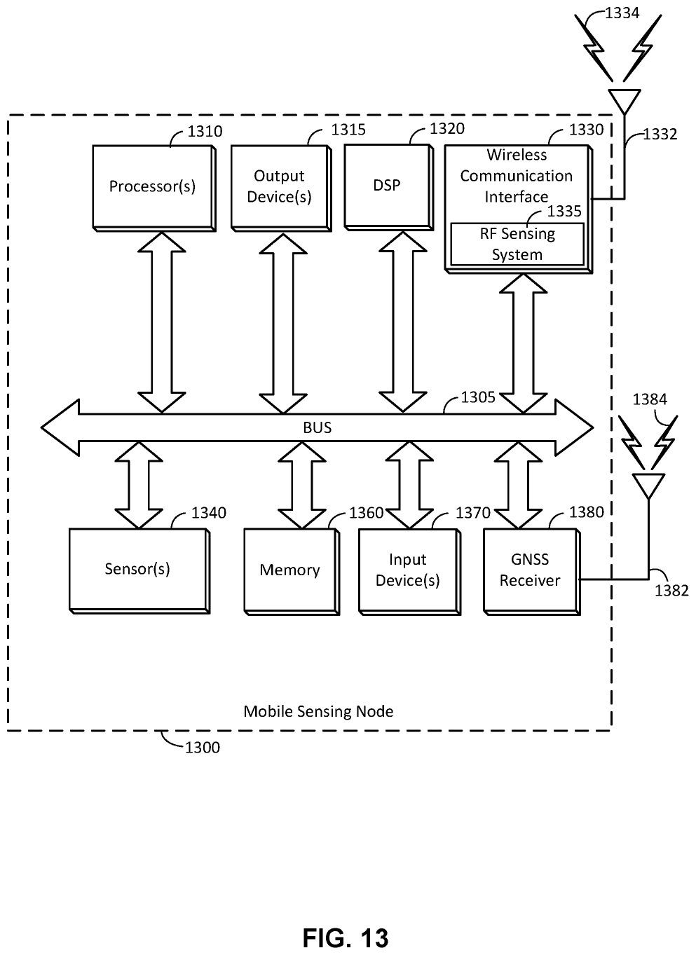

FIG. 5 is a diagram showing an example of an RF sensing system 505 and associated terminology. As used herein, the terms “waveform” and “sequence” and derivatives thereof are used interchangeably to refer to RF signals generated by a transmitter of the RF sensing system and received by a receiver of the RF sensing system for object detection. A “pulse” and derivatives thereof are generally referred to herein as waveforms comprising a sequence or complementary pair of sequences transmitted and received to generate a channel impulse response (CIR). The RF sensing system 505 may comprise a standalone device or may be integrated into a larger electronic device (e.g., the UE disclosed herein), such as a mobile phone, a base station/access node, a satellite, or other type of sensing node as described herein. (Example components of such electronic devices are illustrated in FIGS. 13-15, discussed in detail hereafter.) It can be noted that although the example RF sensing system 505 of FIG. 5 is illustrated in a monostatic configuration, embodiments are not so limited. As noted elsewhere herein, RF sensing nodes may be configured to perform RF sensing in a monostatic, bistatic, or multi-static configuration, or any combination thereof (e.g., depending on the circumstances of a particular instance). As such, components of an RF sensing system 505 within an RF sensing node may vary. For example, RF sensing nodes performing only transmitting or only receiving during RF sensing may include only respective components related to the transmitting or receiving. Again, embodiments may vary, depending on desired functionality.

With regard to the functionality of the RF sensing system 505 in FIG. 5, the RF sensing system 505 can detect the distance, direction, and/or speed of objects of an object 510 by generating a series of transmitted RF signals 512 (comprising one or more pulses). Some of these transmitted RF signals 512 reflect off of the object 510, and these reflected RF signals 514 (or “echoes”) are then processed by the RF sensing system 505 using beamforming (BF) and digital signal processing (DSP) techniques to determine the object's location (azimuth, elevation, velocity (e.g., from Doppler measurements), and range) relative to the RF sensing system 505. CFAR may be part of this processing, but may not necessarily be used in every instance, or “occasion,” in which RF sensing is performed.

To enable RF sensing, RF sensing system 505 may include a processing unit 515, memory 517, multiplexer (mux) 520, Tx processing circuitry 525, and Rx processing circuitry 530. (The RF sensing system 505 may include additional components not illustrated, such as a power source, user interface, or electronic interface). It can be noted, however, that these components of the RF sensing system 505 may be rearranged or otherwise altered in alternative embodiments, depending on desired functionality. Moreover, as used herein, the terms “transmit circuitry” or “Tx circuitry” refer to any circuitry utilized to create and/or transmit the transmitted RF signal 512. Likewise, the terms “receive circuitry” or “Rx circuitry” refer to any circuitry utilized to detect and/or process the reflected RF signal 514. As such, “transmit circuitry” and “receive circuitry” may not only comprise the Tx processing circuitry 525 and Rx processing circuitry 530 respectively but may also comprise the mux 520 and processing unit 515. In some embodiments, the processing unit may compose at least part of a modem and/or wireless communications interface. In some embodiments, more than one processing unit may be used to perform the functions of the processing unit 515 described herein.

The Tx processing circuitry 525 and Rx circuitry 530 may comprise subcomponents for respectively generating and detecting RF signals. As a person of ordinary skill in the art will appreciate, the Tx processing circuitry 525 may therefore include a pulse generator, digital-to-analog converter (DAC), a mixer (for up-mixing the signal to the transmit frequency), one or more amplifiers (for powering the transmission via Tx antenna array 535), etc. The Rx processing circuitry 530 may have similar hardware for processing a detected RF signal. In particular, the Rx processing circuitry 530 may comprise an amplifier (for amplifying a signal received via Rx antenna 540), a mixer for down-converting the received signal from the transmit frequency, an analog-to-digital converter (ADC) for digitizing the received signal, and a pulse correlator providing a matched filter for the pulse generated by the Tx processing circuitry 525. The Rx processing circuitry 530 may therefore use the correlator output as the CIR, which can be processed by the processing unit 515 (or other circuitries). Processing of the CIR may include object detecting, range, speed, or direction of arrival (DoA) estimation.

Beamforming is further enabled by a Tx antenna array 535 and an Rx antenna array 540. Each antenna array 535, 540 comprises a plurality of antenna elements. It can be noted that, although the antenna arrays 535, 540 of FIG. 5 include two-dimensional arrays, embodiments are not so limited. Arrays may simply include a plurality of antenna elements along a single dimension that provides for spatial cancellation between the Tx and Rx sides of the RF sensing system 505. As a person of ordinary skill in the art will appreciate, the relative location of the Tx and Rx sides, in addition to various environmental factors can impact how spatial cancellation may be performed.

It can be noted that the properties of the transmitted RF signal 512 may vary, depending on the technologies utilized. Techniques provided herein can apply generally to “mmWave” technologies, which typically operate at 24-71 GHz, but may include frequencies ranging from 30-300 GHz. This includes, for example, frequencies utilized by the 802.11ad Wi-Fi standard (operating at 60 GHz). That said, some embodiments may utilize RF signals with frequencies outside this range. For example, in some embodiments, 5G frequency bands (e.g., 28 GHz) may be used.

Because RF sensing may be performed in the same frequency bands as communication (e.g., cellular and/or WLAN communication), hardware may be utilized for both communication and RF sensing, as previously noted. For example, one or more of the components of the RF sensing system 505 shown in FIG. 5 may be included in a wireless modem (e.g., Wi-Fi, 5G, or other modems). Additionally, techniques may apply to RF signals comprising any of a variety of pulse types, including compressed pulses (e.g., comprising Chirp, Golay, Barker, Ipatov, or m sequences) may be utilized. That said, embodiments are not limited to such frequencies and/or pulse types. Additionally, because the RF sensing system may be capable of sending RF signals for communication (e.g., using 802.11 communication technology), embodiments may leverage channel estimation used in communication for performing the RF sensing as provided herein. Accordingly, the pulses may be the same as those used for channel estimation in communication.

As noted, the RF sensing system 505 may be integrated into an electronic device in which RF sensing is desired (e.g., mobile device 105 and/or UE 205). For example, the RF sensing system 505, which can perform RF sensing, may be part of the communication hardware found in modern mobile phones. Other devices, too, may utilize the techniques provided herein. These can include, for example, other mobile devices (e.g., tablets, portable media players, laptops, wearable devices, other electronic devices (e.g., security devices, on-vehicle systems, specialized or dedicated RF sensing devices), wireless nodes of the communication network (e.g., access nodes, such as base stations and/or satellites), or the like. That said, electronic devices (e.g., RF sensing nodes) into which an RF sensing system 505 may be integrated are not limited to such devices.

In RF sensing, a wireless signal can be transmitted from one or multiple transmit points and received at one or multiple receive points after being reflected off a target. RF sensing can enable many candidate applications, including intruder detection, animal/pedestrian/unmanned aerial vehicle (UAV) intrusion detection in highways and railways, rainfall monitoring, flooding awareness, autonomous driving, automated guided vehicle (AGV) detection/tracking/collision avoidance, smart parking and assistance, UAV trajectory and tracking, crowd management, sleep/health monitoring, gesture recognition, extended reality (XR) streaming, public safety, search and rescue, and more. Further, RF sensing is expected to be incorporated into wireless standards (e.g., 6G), and therefore may be performed in the future in a cellular network.

Linear FMCW, or LFM, is broadly discussed as a potential waveform to use for 6G joint communication and sensing (JCS). However, as previously noted, LFM is particularly vulnerable to internode interference, has limitations with regard to multiplexing, and has a peak-to-sidelobe level that may not provide enough dynamic range for some use cases. With this in mind, embodiments utilize NLFM (including nonlinear FMCW) that may be compatible with OFDM systems used in cellular communication, may boost multiplex and capability for future 6G use cases, and may provide compatibility with legacy LFM/FMCW design. Further, NLFM can provide a dynamic range sufficient to detect objects that would not be detectable using traditional LFM.

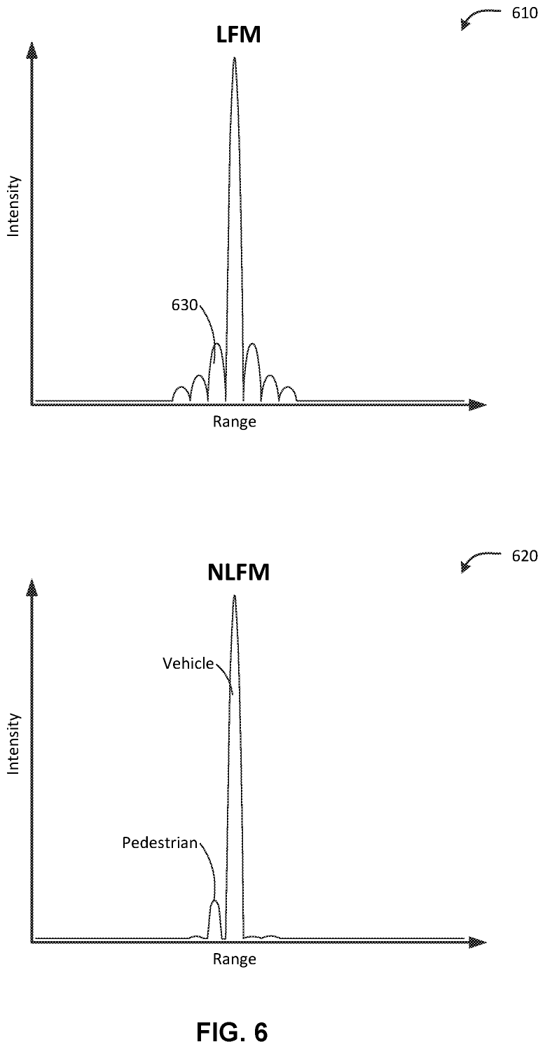

FIG. 6 includes a pair of graphs 610 and 620 that illustrate how NLFM may be capable of providing dynamic range, unattainable by LFM, that can be useful in certain use cases. Each graph 610 and 620 plots intensity over a range for a given traffic scenario, which may correspond to an RF sensing signal received at a sensing node. The first graph 610 represents the receiving signal intensity of a received LFM signal, and the second graph 620 represents the receiving signal intensity of a received NLFM signal. (Applications for RF sensing may include vehicle-based applications, and thus, the sensing node in this case may comprise a vehicle.) As illustrated in the first graph, the LFM signal results in sidelobes 630 that have intensity levels sufficient to mask the presence of a pedestrian, which is detected using NLFM, as shown in graph 620. As can be seen, the use of NLFM can be particularly helpful in applications in which accurate detection of targets is important, including the accurate detection of smaller targets that may be close to larger targets, such as pedestrians next to a bus.

Because there is no universal definition for NLFM signals, embodiments may use NLFM signals that can be relatively easily defined and used. According to some embodiments, such NLFM signals may be represented as a linear combination of Legendre Polynomials (LPs) using the following equation:

$${S}_{NLFM} ( t ) = {\sum }_{n = 1}^{N} {α}_{n} {p}_{2 n} ( t ) , \qquad ( Eqn . 1 )$$

where t is time, p₂ₙ(t) is the nth degree LP at time t, and N is the order of the LPs, and αₙ is the coefficient of the LPs. The resulting S_{NLFM}(t) represents frequency as a function of time.

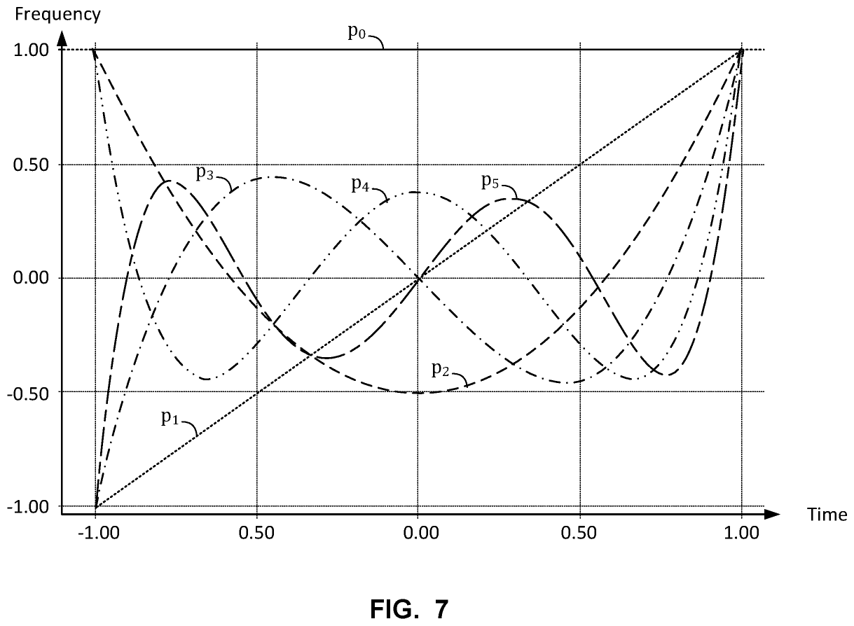

FIG. 7 is a graph that plots degrees (n) of LPs as frequency over time, provided to help illustrate how LPs could provide time-varying frequency. S_{NLFM}(t) of Eqn. 1 may represent a linear combination of these LPs multiplied by coefficient αₙ, up to order N. It can be noted that starting frequency, phase, and amplitude also may vary, which may be defined separately, as desired. Further, according to some embodiments, the degree of LPs may be set to be even, to ensure waveform symmetry (where the ending frequency is substantially the same as the starting frequency) to prevent a frequency jump. (Additional details regarding frequency jump prevention are described below.)

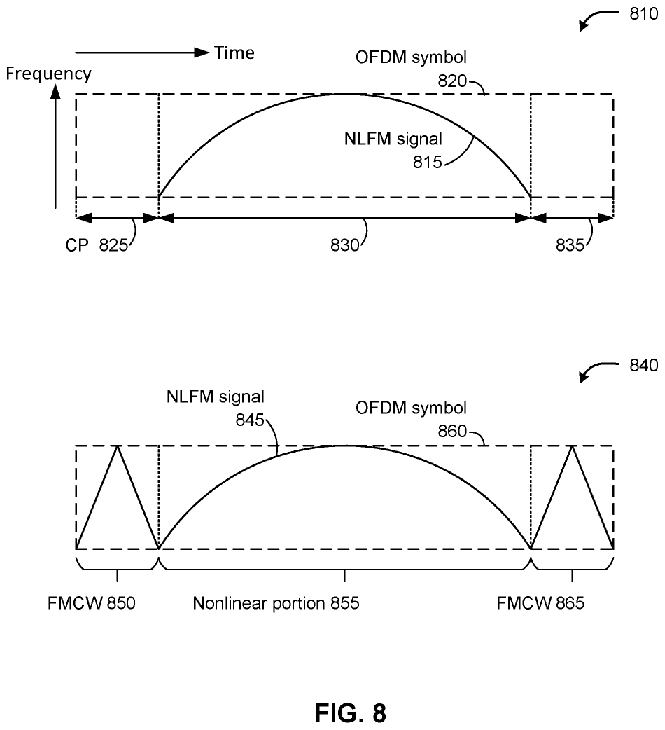

Given the characteristics of the various LPs as shown in FIG. 7, the parameters of Eqn. 1, such as order and coefficient, can be adjusted/optimized for different scenarios and/or for different sensing devices. This optimization may consider various factors, such as balancing performance and complexity, performance in auto-correlation and cross-correlation properties, the main lobe to side lobe ratio/level, any trade-off between main lobe width and dynamic range, or the like. It can be further noted that, according to some embodiments, other nonlinear functions (generally, F(t)) can be used to help ensure the instantaneous frequency at the beginning and end of the designated RF sensing period are substantially the same to facilitate cyclic prefix (CP) design. Additional description with respect to CP considerations is provided below with respect to FIG. 8.

According to some embodiments, NLFM signals may be designed to avoid interference with the OFDM communication scheme typically used in cellular communications, allowing for joint communication and sensing (JCS) functionality by a sensing node such as a UE or base station of a cellular network. To this end, embodiments may utilize NLFM signals that conform with the CP structure of OFDM.

FIG. 8 includes two graphs that illustrate different examples of NLFM signals conforming to a CP structure of OFDM, according to some embodiments. The first graph 810, which may be considered a “zero-tail” OFDM-based NLFM, shows the frequency of a first NLFM signal 815 plotted over time, spanning the length of an OFDM signal 820. In this example, no (“zero”) signal is transmitted during the CP 825 of the OFDM symbol 820. The NLFM signal 815 is then transmitted during an initial portion 830 of the OFDM symbol 820 that follows the CP 825, followed by a second period of time 835 during which no signal is transmitted. According to some embodiments, the period of time 835 may be substantially the same as the period of time of the CP 825.

The second graph 840, which may be considered a CP-OFDM-based NLFM, is a graph similar to the first graph 810, plotting frequency of a second NLFM signal 845. In the second graph, however, the second NLFM signal 845 includes a first FMCW (linear) portion 850 appended to a nonlinear portion 855, where the first FMCW portion 850 is transmitted during the CP, and the nonlinear portion 855 is transmitted during the initial portion of the OFDM symbol 860. A second FMCW portion 865 is appended after the nonlinear portion 855. As such, the NLFM signal 845 may be considered a piecewise signal comprising linear and nonlinear portions. In such embodiments, linear portions may be transmitted in accordance with traditional FMCW techniques, and nonlinear portions may be defined, for example, by nonlinear equations such as Eqn. 1 described above. According to some embodiments, first FMCW portion 850 and second FMCW portion 865 may comprise the same linear signal. Further, as illustrated, the first and second FMCW portions 850, 865 may be symmetric (e.g., triangular, as illustrated in FIG. 8), starting and ending at substantially the same frequency as the nonlinear portion 855, thereby avoiding frequency jumps between portions. By avoiding frequency jumps in this manner, embodiments may use a simple design option for the CP which can enable sensing nodes to perform RF sensing using low complexity analog-based implementations. This can especially be useful for sensing nodes comprising UEs for which implementations may be based on the use of voltage-controlled oscillators (VCOs). That said, some embodiments may utilize asymmetric NLFM signals that result in frequency jumps (e.g., between CP and the nonlinear portion 855).

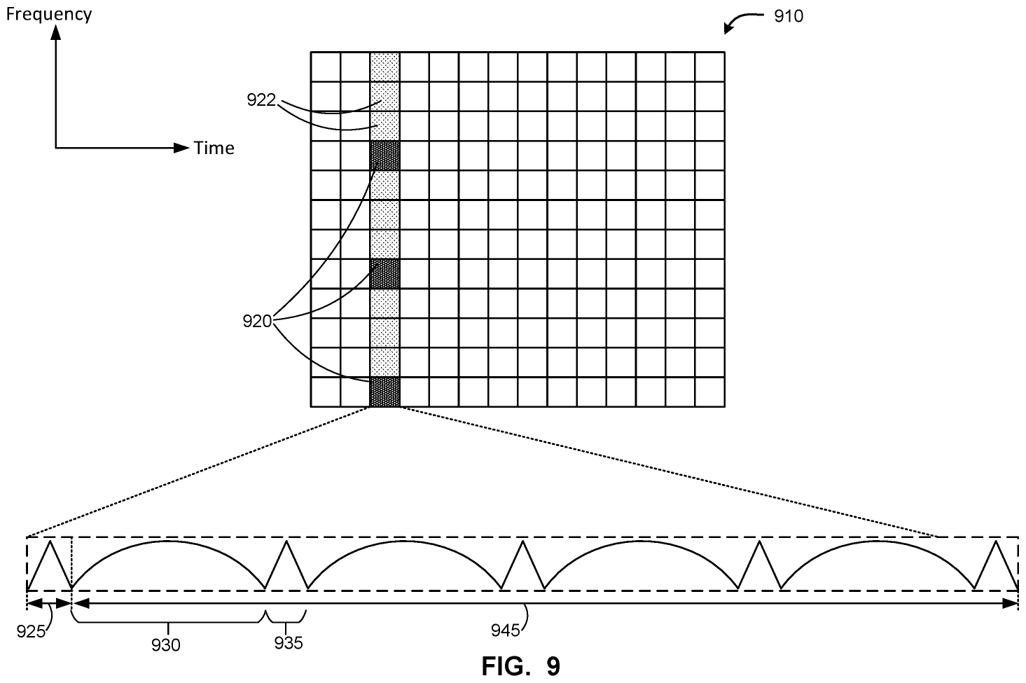

FIG. 9 is a graph illustrating how NLFM signals may be multiplexed, according to some embodiments. Here, a resource block 910 is shown in which the NLFM signal is transmitted at certain resource elements 920 of a symbol within the resource block 910. Other resource elements 922 (only a portion of which are labeled, to avoid clutter) at other subcarriers in the resource block 910 that occur during the symbol may be used for other functions, such as communication.

As illustrated, for each of the resource elements 920 within which the NLFM signal is transmitted, the NLFM signal may be repeated a certain number of times. More specifically, after transmitting a linear (FMCW) portion during a cyclic prefix 925, the NLFM signal (comprising a nonlinear portion 930 followed by a linear portion 935) may be repeated multiple times over the duration of the symbol 945. (It can be noted that the duration of the symbol 945 typically does not include the duration of the cyclic prefix 925.) As illustrated, this may be performed, for example, using CP-OFDM-based NLFM as described previously with respect to FIG. 8.

According to some embodiments, the numerology of the NLFM may meet the following requirement:

$${T}_{OFDM} = β {T}_{NLMF} , \qquad ( Eqn . 2 )$$

where T_{OFDM} is duration of the symbol 945, T_{NLMF} is the duration of the NFLM signal (the combined duration of the nonlinear portion 930 and linear portion 935 in FIG. 9), and B is the number of repetitions. In such embodiments, 1/β of the resource elements of a symbol may be allocated for RF sensing using the NLFM signal, and (as previously noted) the other resource elements of the symbol may be allocated to the OFDM for standard use (e.g., communications). Thus, embodiments may enable coexistence (and orthogonality) between NLFM and OFDM.

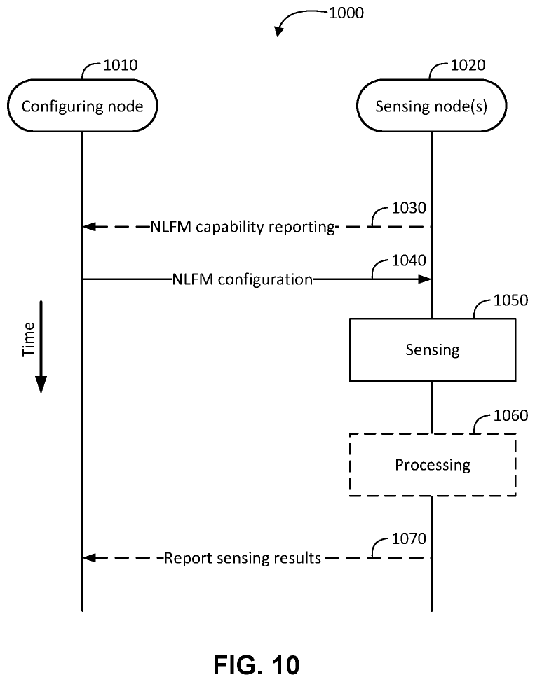

As previously noted, a sensing node may comprise a base station (e.g., gNB) or a UE of a wireless network depending on desired functionality. According to some embodiments, a configuring node may be used to configure the sensing node to use NLFM signals for RF sensing, as described herein. Depending on desired functionality, a configuring node may comprise, for example, a base station or a server (e.g., an SMF 221 or similar server). The way in which a configuring node may configure a sensing node for RF sensing is described in more detail below, with respect to FIG. 10.

FIG. 10 is a message flow diagram of a process 1000 by which a configuring node 1010 may configure one or more sensing nodes 1020 to perform RF sensing using an NLFM signal. Here, arrows (except for the arrow illustrating the flow of time) illustrate communications between the configuring node 1010 and one or more sensing nodes 1020, and dashed lines represent optional functionality (which is described in more detail below). Some or all portions of the process 1000 may be performed as an independent process, and/or may be incorporated into other processes executed by sensing nodes (e.g., other types of capability reporting, sensing configuration, etc.).

The process 1000 may begin with the optional capability reporting, as illustrated by arrow 1030. Generally speaking, this capability reporting may indicate the capabilities of the sensing node(s) 1020 with respect to which NLFM signals the sensing node(s) 1020 may and/or may not be capable of using for RF sensing. This can include, for example, the categories and parameters of compatible non-linear functions, such as a maximum order of N and/or maximum frequency ramping speed (which may apply to both linear and/or nonlinear portions of an NLFM signal). The optionality of the NLFM capability reporting may be due to certain circumstances in which such capabilities are known or established beforehand (e.g., standardized), in which case NLFM capability reporting may not be needed.

The process 1000 may continue with the functionality of arrow 1040, in which the configuring node 1010 provides an NLFM configuration to the sensing node(s) 1020. As noted previously, the NLFM configuration at arrow 1040 may include NLFM parameters, such as an order and/or the coefficient of the LPs. As previously noted, these parameters may be based on various factors that may be specific to a particular implementation or scenario. According to some embodiments, the NLFM configuration at arrow 1040 may be indicative of such parameters, but may indicate the parameters and/or other aspects of the NLFM signal using an index number or other reference to a standard, if the parameters and/or signals have been standardized.

According to some embodiments, the NLFM parameters may be associated with a UE ID or cell ID. That is, different parameters may be used for different sensing nodes, and may be based on an identifier of each sensing node. By optimizing the coefficient of the polynomials, for example, embodiments can reduce the cross-correlation among different NLFM signals with different parameters. According to some embodiments, a group of sensing nodes may share the same NLMF parameters, but the NLFM signals may be multiplexed through other ways, such as: cyclic-shift-based like multiplexing, comb-based multiplexing, and/or other techniques, such as time division multiplexing (TDM), frequency division multiplexing (FDM), space division multiplexing (SDM), or the like.

According to some embodiments, a group of parameters initially may be sent to the sensing node(s) 1020, and a subsequent triggering message may include a particular parameter to use for a particular RF sensing instance. For example, in cell-wise sensing, a base station (e.g., gNB) may configure the sensing node(s) 1020 with an NLFM configuration that includes multiple parameter sets. This can be done, for example, using radio resource control (RRC). The base station may then subsequently send a trigger message to the sensing node(s) 1020, indicating which parameter set (e.g., using an index number or other identifier of the parameter set) of the multiple parameter sets to use for particular RF sensing instance. The trigger message may be sent, for example, using downlink control information (DCI) or a medium access control-control element (MAC-CE).

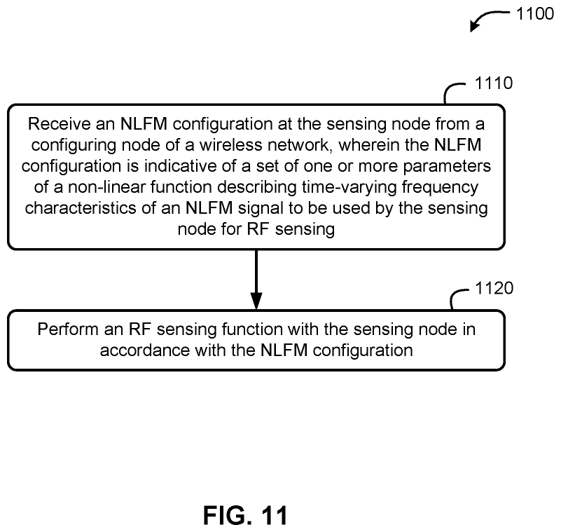

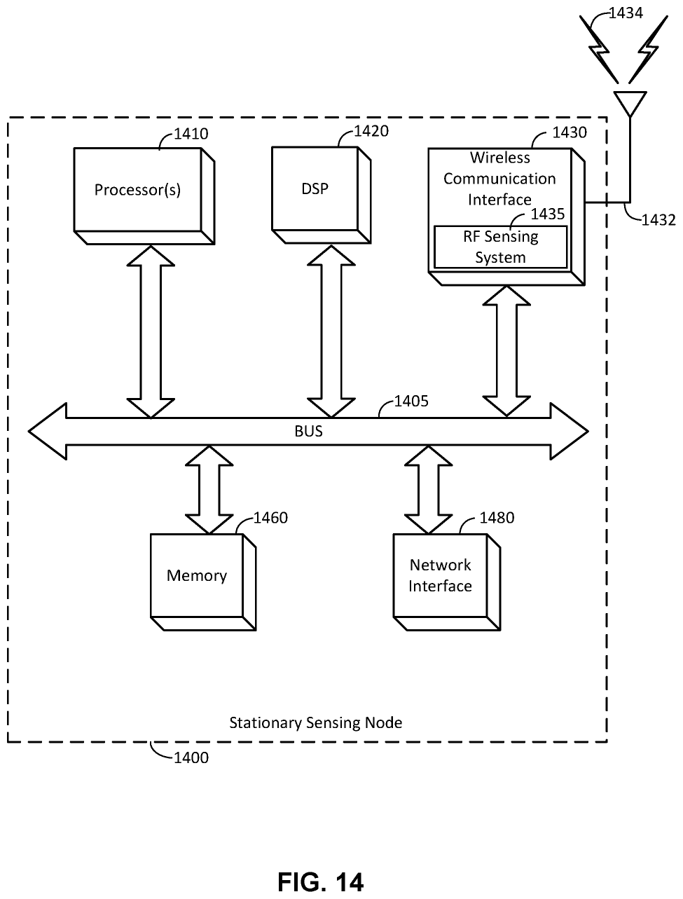

FIG. 11 is a flow diagram of a process 1100 of NLFM RF sensing, according to an embodiment. Some or all of the functionality illustrated in FIG. 11 may be performed by hardware and/or software components of a sensing node, such as a mobile sensing node (e.g., UE) or a stationary sensing node (e.g., base station (e.g., gNB)) of a wireless cellular network. Example components of a mobile sensing node and stationary sensing node are described in more detail below with respect to FIGS. 13 and 14, respectively.

At block 1110, the functionality comprises receiving an NLFM configuration at the sensing node from a configuring node of a wireless network, wherein the NLFM configuration is indicative of a set of one or more parameters of a non-linear function describing time-varying frequency characteristics of an NLFM signal to be used by the sensing node for RF sensing. As described in the embodiments herein, these parameters may include, for example, an order of Legendre Polynomials (LPs) of the non-linear function, and a coefficient of the LPs. According to some embodiments, a degree of the LPs may be even, and the NLFM signal may begin and end on substantially the same frequency.

As noted in the embodiments herein (e.g., FIG. 10) a sensing node may provide a configuring node with NLFM capability, prior to the determination of the NLFM configuration. As such, embodiments of the method 1100 may further comprise sending NLFM capability information from the sensing node to the configuring node prior to receiving the NLFM configuration, wherein the NLFM capability information is indicative of: a maximum order of LPs the sensing node is capable of using, a maximum frequency ramping speed, or a combination thereof.

Means for performing functionality at block 1110 may comprise a bus 1305, one or more processors 1310, digital signal processor(s) 1320, wireless communication interface 1330 (which may include an RF sensing system 1335), memory 1360, and/or other components of a mobile sensing node, as illustrated in FIG. 13. Additionally, or alternatively, means for performing functionality at block 1110 may comprise a bus 1405, one or more processors 1410, digital signal processor(s) 1420, wireless communication interface 1430 (which may include an RF sensing system 1435), memory 1460, and/or other components of a mobile sensing node, as illustrated in FIG. 14.

The functionality at block 1120 comprises performing an RF sensing function with the sensing node in accordance with the NLFM configuration. As noted herein, the sensing node may comprise a receiving (Rx) and/or transmitting (Tx) sensing node. And thus, performing the RF sensing function may vary depending on whether the sensing node is transmitting or receiving the NLFM signal. For example, according to some embodiments, the sensing node may comprise a transmit (Tx) sensing node, and wherein performing the RF sensing function in accordance with the NLFM configuration comprises transmitting the NLFM signal. In such embodiments, transmitting the NLFM signal may comprise transmitting one or more repetitions of the NLFM signal in a symbol of an orthogonal frequency division multiplexing (OFDM) communication scheme. According to some embodiments, the OFDM communication scheme may comprise cyclic prefix (CP)-OFDM in which each OFDM symbol is preceded by a period of time allocated for a CP, and wherein transmitting the one or more repetitions of the NLFM signal in the symbol comprises transmitting the one or more repetitions such that there is a first period of time prior to the beginning of the one or more repetitions during which the sensing node makes no transmission, the first period of time comprising the period of time allocated for a CP immediately preceding the symbol; and there is a second period of time between the end of the symbol and the end of the one or more repetitions during which the sensing node makes no transmission. According to some embodiments, the OFDM communication scheme may comprise CP-OFDM in which each OFDM symbol is preceded by a period of time allocated for a CP, and wherein the method may further comprise appending a first frequency-modulated continuous wave (FMCW) signal to the beginning of the one or more repetitions such that the first FMCW signal is transmitted during the period of time allocated for a CP immediately preceding the symbol, and appending a second FMCW signal to the end of the one or more repetitions such that the second FMCW signal is transmitted prior to end of the symbol. In such embodiments, there may be substantially no frequency jump between the first FMCW signal and the beginning of the one or more repetitions, and there may be substantially no frequency jump between the second FMCW signal and the end of the one or more repetitions. As noted previously, the avoidance of frequency jumps in this manner can make it easier for sensing nodes (especially low-cost UEs) to generate the signal. According to some embodiments, transmitting the one or more repetitions of the NLFM signal in the symbol comprises transmitting the one or more repetitions using a plurality of subcarriers.

According to other examples, the sensing node may comprise a receive (Rx) sensing node, and wherein performing the RF sensing function in accordance with the NLFM configuration may comprise receiving the NLFM signal. In such embodiments, the sensing node may report sensing results (e.g., as shown in FIG. 10). Thus, some embodiments of the process 1100 may comprise detecting, with the sensing node, one or more targets from the received NLFM signal, and sending a report of the sensing results from the sensing node to the configuring node, the report indicative of the one or more targets.

Additionally, or alternatively, as described herein, embodiments may provide multiple sets of parameters in the NLFM configuration, where certain triggers may prompt the use of certain parameters. Thus, according to some embodiments of the process 1100, the set of parameters may comprise one of a plurality of parameter sets included in the NLFM configuration. In such embodiments, performing the RF sensing function may be based at least in part on a trigger message received from a base station, the trigger message identifying the set of parameters from the plurality of parameter sets.

Finally, embodiments described herein may be directed toward the transmission of a repeating signal comprising an NLFM portion followed by an FMCW portion. This may be performed, for example, during and OFDM symbol. An illustration of this is shown in FIG. 9. Thus, according to some embodiments, performing the RF sensing function in accordance with the NLFM configuration may comprise generating a sensing signal for transmission, reception, or both, the sensing signal comprising one or more repetitions, wherein each repetition comprises: the NLFM signal, and an FMCW signal appended at the end of the NLFM signal.

Means for performing functionality at block 1120 may comprise a bus 1305, one or more processors 1310, digital signal processor(s) 1320, wireless communication interface 1330 (which may include an RF sensing system 1335), memory 1360, and/or other components of a mobile sensing node, as illustrated in FIG. 13. Additionally, or alternatively, means for performing functionality at block 1120 may comprise a bus 1405, one or more processors 1410, digital signal processor(s) 1420, wireless communication interface 1430 (which may include an RF sensing system 1435), memory 1460, and/or other components of a mobile sensing node, as illustrated in FIG. 14.

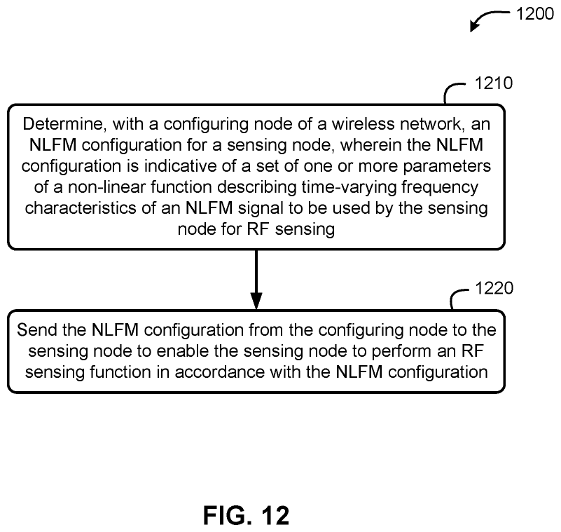

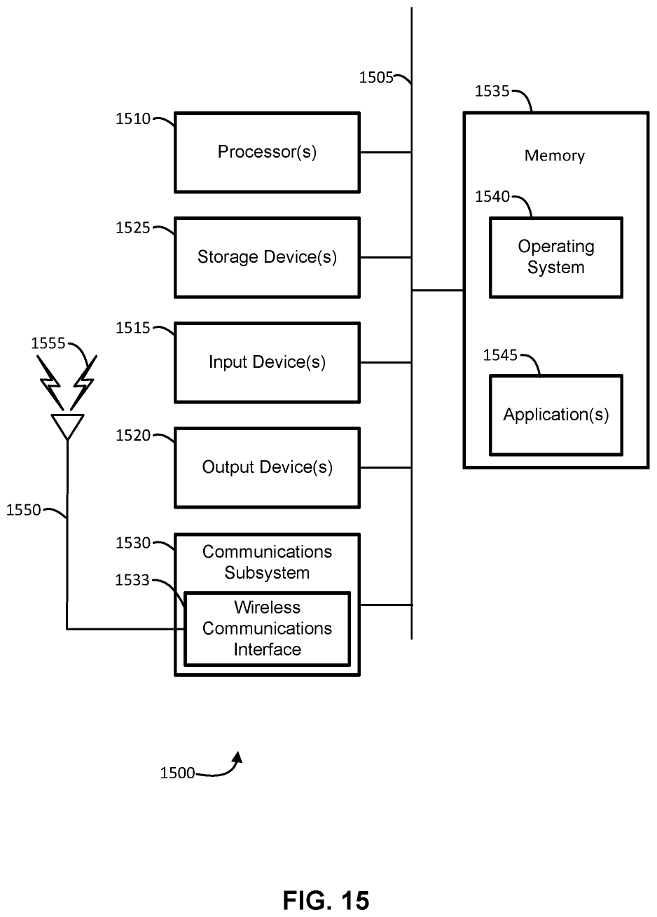

FIG. 12 is a flow diagram of a process 1200 of providing an NLFM configuration for RF sensing, according to an embodiment. Some or all of the functionality illustrated in FIG. 12 may be performed by hardware and/or software components of a configuring node (e.g., base station or sensing server) of a wireless cellular network. Example components of a configuring node are described in more detail below with respect to FIG. 15.

At block 1210, the functionality comprises determining, with a configuring node of a wireless network, an NLFM configuration for a sensing node, wherein the NLFM configuration is indicative of a set of one or more parameters of a non-linear function describing time-varying frequency characteristics of an NLFM signal to be used by the sensing node for RF sensing. As noted in the embodiments herein (e.g., FIG. 10), this determination may be based, at least in part, on capability information received by the sensing node. According to some embodiments, the method 1200 may further include receiving capability information at the configuring node from the sensing node, prior to determining the NLFM configuration, wherein the NLFM capability information is indicative of: a maximum order of LPs the sensing node is capable of using, a maximum frequency ramping speed, or a combination thereof. According to some embodiments, the set of parameters may include, an order of Legendre Polynomials (LPs) of the non-linear function, and a coefficient of the LPs. In such embodiments, a degree of the LPs may be even, and the NLFM signal may begin and end on substantially the same frequency. Again, this can help reduce frequency jumping that may be difficult for certain sensing node to perform.

Means for performing functionality at block 1210 may comprise a bus 1505, one or more processors 1510, a communications subsystem 1530, memory 1535, and/or other components of a mobile sensing node, as illustrated in FIG. 15.

At block 1220, the functionality comprises sending the NLFM configuration from the configuring node to the sensing node to enable the sensing node to perform an RF sensing function in accordance with the NLFM configuration. The sending may be performed in accordance with relevant standards and/or protocols. For example, the configuration may be provided using LPP or a similar higher-layer protocol used by a sensing server. Additionally or alternatively, the configuration may be provided via RRC, MAC-CE, or another protocol used between a base station and a UE if the configuring node comprises a serving base station, for example, to a UE comprising the sensing node.

Means for performing functionality at block 1220 may comprise a bus 1505, one or more processors 1510, a communications subsystem 1530, memory 1535, and/or other components of a mobile sensing node, as illustrated in FIG. 15.

FIG. 13 is a block diagram of an embodiment of a mobile sensing node 1300, which can be utilized as described herein. For example, mobile sensing node 1300 may correspond to a mobile device (e.g., mobile device 105 of FIG. 1), UE (e.g., UE 205 of FIG. 2), sensing node (e.g., sensing node 1020 of FIG. 10), or the like, as described herein. Further, as described below, the mobile sensing node 1300 may implement an RF sensing system 1335, which may correspond to the RF sensing system 505 described above with respect to FIG. 5. Moreover, according to some embodiments, a mobile sensing node 1300 may function as a configuring node or device, as described herein, in some scenarios. As such, the mobile sensing node 1300 may be capable of performing some or all of the functionality described in the methods regarding sensing nodes and/or configuring nodes as described herein. It should be noted that FIG. 13 is meant only to provide a generalized illustration of various components, any or all of which may be utilized as appropriate.

The mobile sensing node 1300 is shown comprising hardware elements that can be electrically coupled via a bus 1305 (or may otherwise be in communication, as appropriate). The hardware elements may include a processor(s) 1310 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1310 may comprise one or more processing units, which may be housed in a single integrated circuit (IC) or multiple ICs. As shown in FIG. 13, some embodiments may have a separate DSP 1320, depending on desired functionality. Location determination and/or other determinations based on wireless communication may be provided in the processor(s) 1310 and/or wireless communication interface 1330 (discussed below). The mobile sensing node 1300 also can include one or more input devices 1370, which can include without limitation one or more keyboards, touch screens, touch pads, microphones, buttons, dials, switches, and/or the like; and one or more output devices 1315, which can include without limitation one or more displays (e.g., touch screens), light emitting diodes (LEDs), speakers, and/or the like.

The mobile sensing node 1300 may also include a wireless communication interface 1330, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the mobile sensing node 1300 to communicate and/or perform positioning with other devices as described in the embodiments above, with respect to WLAN and/or cellular technologies. The wireless communication interface 1330 may permit data and signaling to be communicated (e.g., transmitted and received) with NG-RAN nodes of a network, for example, via eNBs, gNBs, ng-eNBs, access points, NTN satellites, various base stations, TRPs, and/or other access node types, and/or other network components, computer systems, and/or any other electronic devices communicatively coupled with TRPs, as described herein. The communication can be carried out via one or more wireless communication antenna(s) 1332 that send and/or receive wireless signals 1334. According to some embodiments, the wireless communication antenna(s) 1332 may comprise a plurality of discrete antennas, antenna arrays, or any combination thereof. The antenna(s) 1332 may be capable of transmitting and receiving wireless signals using beams (e.g., Tx beams and Rx beams). Beam formation may be performed using digital and/or analog beam formation techniques, with respective digital and/or analog circuitry. The wireless communication interface 1330 may include such circuitry.

As noted above, the mobile sensing node 1300 may implement an RF sensing system 1335. The RF sensing system 1335 may comprise the hardware and/or software elements described above with respect to FIG. 3. As illustrated in FIG. 13 and noted above, some or all of the RF sensing system 1335 may be implemented within a wireless communication interface 1330, which may utilize certain components for both communication and RF sensing. That said, embodiments are not so limited. Alternative embodiments may implement some or all of the RF sensing system 1335 separate from the wireless communication interface 1330 (e.g., in cases where RF sensing may utilize different frequencies and/or different hardware/software components than the wireless communication interface 1330).

Depending on desired functionality, the wireless communication interface 1330 may comprise a separate receiver and transmitter, or any combination of transceivers, transmitters, and/or receivers to communicate with base stations (e.g., ng-eNBs and gNBs) and other terrestrial transceivers, such as wireless devices and access points, as well as NTN satellites. The mobile sensing node 1300 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The mobile sensing node 1300 can further include sensor(s) 1340. Sensor(s) 1340 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information. As noted in the description above, sensors 1340 may be used, for example, to determine a velocity of the mobile sensing node, which may be reported to a configuring device, according to some embodiments.

Embodiments of the mobile sensing node 1300 may also include a Global Navigation Satellite System (GNSS) receiver 1380 capable of receiving signals 1384 from one or more GNSS satellites using an antenna 1382 (which could be the same as antenna 1332). Positioning based on GNSS signal measurement can be utilized to complement and/or incorporate the techniques described herein. The GNSS receiver 1380 can extract a position of the mobile sensing node 1300, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS), and/or the like. Moreover, the GNSS receiver 1380 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1380 is illustrated in FIG. 13 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1310, DSP 1320, and/or a processor within the wireless communication interface 1330 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 1310 or DSP 1320.

The mobile sensing node 1300 may further include and/or be in communication with a memory 1360. The memory 1360 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1360 of the mobile sensing node 1300 also can comprise software elements (not shown in FIG. 13), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1360 that are executable by the mobile sensing node 1300 (and/or processor(s) 1310 or DSP 1320 within mobile sensing node 1300). In some embodiments, then, such code and/or instructions can be used to configure and/or adapt a general-purpose computer (or other device) to perform one or more operations in accordance with the described methods.

FIG. 14 is a block diagram of an embodiment of a stationary sensing node 1400, which can be utilized as described herein. For example, stationary sensing node 1400 may correspond to a base station or access node (e.g., base station 130 of FIG. 1 and/or access nodes 210, 214, and 216 of FIG. 2), sensing node (e.g., sensing node 1020 of FIG. 10), or the like, as described herein. Further, as described below, the stationary sensing node 1400 may implement an RF sensing system 1435, which may correspond to the RF sensing system described above with respect to FIG. 5. Moreover, according to some embodiments, a stationary sensing node 1400 may function as a configuring node or device, as described herein, in some scenarios. As such, the stationary sensing node 1400 may be capable of performing some or all of the functionality described in the methods regarding sensing nodes and/or configuring nodes as described herein. It should be noted that FIG. 14 is meant only to provide a generalized illustration of various components, any or all of which may be utilized as appropriate. In some embodiments, the stationary sensing node 1400 may correspond to a gNB, an ng-eNB, and/or (more generally) a TRP. In some cases, a stationary sensing node 1400 may comprise multiple TRPs—e.g. with each TRP associated with a different antenna or a different antenna array of the stationary sensing node 1400 (e.g., 1432). As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP.

The functionality performed by a stationary sensing node 1400 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. The functionality of these functional components may be performed by one or more of the hardware and/or software components illustrated in FIG. 14.

The stationary sensing node 1400 is shown comprising hardware elements that can be electrically coupled via a bus 1405 (or may otherwise be in communication, as appropriate). The hardware elements may include a processor(s) 1410 which can include without limitation one or more general-purpose processors, one or more special-purpose processors (such as digital signal processor (DSP) chips, graphics acceleration processors, application-specific integrated circuits (ASICs), and/or the like), and/or other processing structure or means. As shown in FIG. 14, some embodiments may have a separate DSP 1420, depending on desired functionality. Location determination and/or other determinations based on wireless communication may be provided in the processor(s) 1410 and/or wireless communication interface 1430 (discussed below), according to some embodiments. The stationary sensing node 1400 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The stationary sensing node 1400 might also include a wireless communication interface 1430, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the stationary sensing node 1400 to communicate as described herein. The wireless communication interface 1430 may permit data and signaling to be communicated (e.g., transmitted and received) to UEs, other base stations/TRPs (e.g., eNBs, gNBs, and ng-eNBs), and/or other network components, computer systems, and/or other electronic devices described herein. The communication can be carried out via one or more wireless communication antenna(s) 1432 that send and/or receive wireless signals 1434. According to some embodiments, one or more wireless communication antenna(s) 1432 may comprise one or more antenna arrays, which may be capable of beamforming.

As noted above, the stationary sensing node 1400 may implement an RF sensing system 1435. The RF sensing system 1435 may comprise the hardware and/or software elements described above with respect to FIG. 3. As illustrated in FIG. 14 and noted above, some or all of the RF sensing system 1435 may be implemented within a wireless communication interface 1430, which may utilize certain components for both communication and RF sensing. That said, embodiments are not so limited. Alternative embodiments may implement some or all of the RF sensing system 1435 separate from the wireless communication interface 1430 (e.g., in cases where RF sensing may utilize different frequencies and/or different hardware/software components then the wireless communication interface 1430).

The stationary sensing node 1400 may also include a network interface 1480, which can include support of wireline communication technologies. The network interface 1480 may include a modem, network card, chipset, and/or the like. The network interface 1480 may include one or more input and/or output communication interfaces to permit data to be exchanged with a network, communication network servers, computer systems, and/or any other electronic devices described herein.

In many embodiments, the stationary sensing node 1400 may further comprise a memory 1460. The memory 1460 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1460 of the stationary sensing node 1400 also may comprise software elements (not shown in FIG. 14), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1460 that are executable by the stationary sensing node 1400 (and/or processor(s) 1410 or DSP 1420 within stationary sensing node 1400). In some embodiments, then, such code and/or instructions can be used to configure and/or adapt a general-purpose computer (or other device) to perform one or more operations in accordance with the described methods.

FIG. 15 is a block diagram of an embodiment of a computer system 1500, which may be used, in whole or in part, to provide the functions of one or more components and/or devices as described in the embodiments herein. The computer system 1500, for example, may be utilized within and/or executed by a server (e.g., location server/LMF or sensing server/SMF) or base station (e.g., gNB), which may perform the functions of a configuring node (e.g., configuring node 1010 of FIG. 10) as described herein. It should be noted that FIG. 15 is meant only to provide a generalized illustration of various components, any or all of which may be utilized as appropriate. FIG. 15, therefore, broadly illustrates how individual system elements may be implemented in a relatively separated or relatively more integrated manner. In addition, it can be noted that components illustrated by FIG. 15 can be localized to a single device and/or distributed among various networked devices, which may be disposed at different geographical locations.

The computer system 1500 is shown comprising hardware elements that can be electrically coupled via a bus 1505 (or may otherwise be in communication, as appropriate). The hardware elements may include processor(s) 1510, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1500 also may comprise one or more input devices 1515, which may comprise without limitation a mouse, a keyboard, a camera, a microphone, and/or the like; and one or more output devices 1520, which may comprise without limitation a display device, a printer, and/or the like.

The computer system 1500 may further include (and/or be in communication with) one or more non-transitory storage devices 1525, which can comprise, without limitation, local and/or network accessible storage, and/or may comprise, without limitation, a disk drive, a drive array, an optical storage device, a solid-state storage device, such as a random-access memory (RAM) and/or read-only memory (ROM), which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1500 may also include a communications subsystem 1530, which may comprise wireless communication technologies managed and controlled by a wireless communication interface 1533, as well as wired technologies (such as Ethernet, coaxial communications, universal serial bus (USB), and the like). The wireless communication interface 1533 may comprise one or more wireless transceivers that may send and receive wireless signals 1555 (e.g., signals according to 5G NR or LTE) via wireless antenna(s) 1550. Thus the communications subsystem 1530 may comprise a modem, a network card (wireless or wired), an infrared communication device, a wireless communication device, and/or a chipset, and/or the like, which may enable the computer system 1500 to communicate on any or all of the communication networks described herein to any device on the respective network, including UE, base stations and/or other transmission reception points (TRPs), satellites, and/or any other electronic devices described herein. Hence, the communications subsystem 1530 may be used to receive and send data as described in the embodiments herein.

In many embodiments, the computer system 1500 will further comprise a working memory 1535, which may comprise a RAM or ROM device, as described above. Software elements, shown as being located within the working memory 1535, may comprise an operating system 1540, device drivers, executable libraries, and/or other code, such as one or more applications 1545, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1525 described above. In some cases, the storage medium might be incorporated within a computer system, such as computer system 1500. In other embodiments, the storage medium might be separate from a computer system (e.g., a removable medium, such as an optical disc), and/or provided in an installation package, such that the storage medium can be used to program, configure, and/or adapt a general-purpose computer with the instructions/code stored thereon. These instructions might take the form of executable code, which is executable by the computer system 1500 and/or might take the form of source and/or installable code, which, upon compilation and/or installation on the computer system 1500 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description, embodiments may include different combinations of features. Implementation examples are described in the following numbered clauses:
Clause 1: A method at a sensing node of non-linear frequency-modulated (NLFM) radio frequency (RF) sensing, the method including: receiving an NLFM configuration at the sensing node from a configuring node of a wireless network, where the NLFM configuration is indicative of a set of one or more parameters of a non-linear function describing time-varying frequency characteristics of an NLFM signal to be used by the sensing node for RF sensing; and performing an RF sensing function with the sensing node in accordance with the NLFM configuration.
Clause 2: The method of Clause 1, where the set of parameters includes: an order of Legendre Polynomials (LPs) of the non-linear function, and a coefficient of the LPs.
Clause 3: The method of Clause 1 or Clause 2, where a degree of the LPs is even, and the NLFM signal begins and ends on substantially the same frequency.
Clause 4: The method of any one of Clauses 1-3, further including sending NLFM capability information from the sensing node to the configuring node prior to receiving the NLFM configuration, where the NLFM capability information is indicative of: a maximum order of LPs the sensing node is capable of using, a maximum frequency ramping speed, or a combination thereof.
Clause 5: The method of any one of Clauses 1-4, where the sensing node includes a user equipment (UE) or a base station.
Clause 6: The method of any one of Clauses 1-5, where: the set of parameters includes one of a plurality of parameter sets included in the NLFM configuration; and performing the RF sensing function is based at least in part on a trigger message received from a base station, the trigger message identifying the set of parameters from the plurality of parameter sets.
Clause 7: The method of any one of Clauses 1-6, where the sensing node includes a transmit (Tx) sensing node, and where performing the RF sensing function in accordance with the NLFM configuration includes transmitting the NLFM signal.
Clause 8: The method of Clause 7, where transmitting the NLFM signal includes transmitting one or more repetitions of the NLFM signal in a symbol of an orthogonal frequency division multiplexing (OFDM) communication scheme.
Clause 9: The method of Clause 8, where the OFDM communication scheme includes cyclic prefix (CP)-OFDM in which each OFDM symbol is preceded by a period of time allocated for a CP, and where transmitting the one or more repetitions of the NLFM signal in the symbol includes transmitting the one or more repetitions such that: there is a first period of time prior to the beginning of the one or more repetitions during which the sensing node makes no transmission, the first period of time includes the period of time allocated for a CP immediately preceding the symbol; and there is a second period of time between the end of the symbol and the end of the one or more repetitions during which the sensing node makes no transmission.
Clause 10: The method Clause 8, where the OFDM communication scheme includes CP-OFDM in which each OFDM symbol is preceded by a period of time allocated for a CP, and where the method further includes: appending a first frequency-modulated continuous wave (FMCW) signal to the beginning of the one or more repetitions such that the first FMCW signal is transmitted during the period of time allocated for a CP immediately preceding the symbol, and appending a second FMCW signal to the end of the one or more repetitions such that the second FMCW signal is transmitted prior to end of the symbol.
Clause 11: The method of Clause 10, where: there is substantially no frequency jump between the first FMCW signal and the beginning of the one or more repetitions, and there is substantially no frequency jump between the second FMCW signal and the end of the one or more repetitions.
Clause 12: The method of Clause 8-11, where transmitting the one or more repetitions of the NLFM signal in the symbol includes transmitting the one or more repetitions using a plurality of subcarriers.
Clause 13: The method of any one of Clauses 1-12, where the sensing node includes a receive (Rx) sensing node, and where performing the RF sensing function in accordance with the NLFM configuration includes receiving the NLFM signal.
Clause 14: The method of Clause 13, further including: detecting, with the sensing node, one or more targets from the received NLFM signal; and sending a report of the sensing results from the sensing node to the configuring node, the report indicative of the one or more targets.
Clause 15: The method of any one of Clauses 1-14, where performing the RF sensing function in accordance with the NLFM configuration includes generating a sensing signal for transmission, reception, or both, the sensing signal includes one or more repetitions, where each repetition includes: the NLFM signal, and an FMCW signal appended at the end of the NLFM signal.
Clause 16: A method of providing a non-linear frequency-modulated (NLFM) configuration for radio frequency (RF) sensing, the method includes: determining, with a configuring node of a wireless network, an NLFM configuration for a sensing node, where the NLFM configuration is indicative of a set of one or more parameters of a non-linear function describing time-varying frequency characteristics of an NLFM signal to be used by the sensing node for RF sensing; and sending the NLFM configuration from the configuring node to the sensing node to enable the sensing node to perform an RF sensing function in accordance with the NLFM configuration.
Clause 17: The method of Clause 16, where the set of parameters includes: an order of Legendre Polynomials (LPs) of the non-linear function, and a coefficient of the LPs.
Clause 18: The method of Clause 16 or Clause 17, where a degree of the LPs is even, and the NLFM signal begins and ends on substantially the same frequency.
Clause 19: The method of any one of Clauses 16-18, further includes receiving NLFM capability information at the configuring node from the sensing node, prior to determining the NLFM configuration, where on the NLFM capability information is indicative of: a maximum order of LPs the sensing node is capable of using, a maximum frequency ramping speed, or a combination thereof.
Clause 20: The method of any one of Clauses 16-19, where the configuring node includes a base station or a server of the wireless network.
Clause 21: The method of any one of Clauses 16-20, where the sensing node includes a transmit (Tx) sensing node, a receive (Rx) sensing node, or both.
Clause 22: A sensing node including: one or more transceivers; one or more memories; and one or more processors communicatively coupled with the one or more transceivers and the one or more memories, the one or more processors configured to: receive, via the one or more transceivers, an NLFM configuration at the sensing node from a configuring node of a wireless network, where the NLFM configuration is indicative of a set of one or more parameters of a non-linear function describing time-varying frequency characteristics of an NLFM signal to be used by the sensing node for RF sensing; and perform an RF sensing function with the one or more transceivers in accordance with the NLFM configuration.
Clause 23: The sensing node of Clause 22, where the one or more processors configured to send NLFM capability information from the sensing node to the configuring node prior to receiving the NLFM configuration, and where the one or more processors configured to include, in the NLFM capability information, information indicative of: a maximum order of LPs the sensing node is capable of using, a maximum frequency ramping speed, or a combination thereof.
Clause 24: The sensing node of Clause 22 or Clause 23, where the one or more processors are configured to perform the RF sensing function is based at least in part on a trigger message received from a base station, the trigger message identifying the set of parameters from a plurality of parameter sets included in the NLFM configuration.
Clause 25: The sensing node of any one of Clauses 22-24, where the sensing node may include a transmit (Tx) sensing node, and where, to perform the RF sensing function in accordance with the NLFM configuration, the one or more processors are configured to transmit the NLFM signal via the one or more transceivers.
Clause 26: The sensing node of any one of Clauses 22-25, to transmit the NLFM signal, the one or more processors are configured to transmit one or more repetitions of the NLFM signal in a symbol of an orthogonal frequency division multiplexing (OFDM) communication scheme.
Clause 27: The sensing node of any one of Clauses 22-26, where, to perform the RF sensing function in accordance with the NLFM configuration, the one or more processors are configured to generate a sensing signal for transmission, reception, or both, such that the sensing signal includes one or more repetitions, and each repetition includes: the NLFM signal, and an FMCW signal appended at the end of the NLFM signal.
Clause 28: A configuring node for providing a non-linear frequency-modulated (NLFM) configuration for radio frequency (RF) sensing, the configuring node may include: one or more transceivers; one or more memories; and one or more processors communicatively coupled with the one or more transceivers and the one or more memories, the one or more processors configured to: determine an NLFM configuration for a sensing node, where the NLFM configuration is indicative of a set of one or more parameters of a non-linear function describing time-varying frequency characteristics of an NLFM signal to be used by the sensing node for RF sensing; and send the NLFM configuration via the one or more transceivers to the sensing node to enable the sensing node to perform an RF sensing function in accordance with the NLFM configuration.
Clause 29: The configuring node of Clause 28, where the one or more processors are configured to receive NLFM capability information from the sensing node prior to determining the NLFM configuration, where on the NLFM capability information is indicative of: a maximum order of LPs the sensing node is capable of using, a maximum frequency ramping speed, or a combination thereof.
Clause 30: The configuring node of Clause 28 or Clause 29, where the configuring node may include a base station or a server of the wireless network.
Clause 31: An apparatus having means for performing the method of any one of Clauses 1-21.
Clause 32: A non-transitory computer-readable medium storing instructions, the instructions comprising code for performing the method of any one of Clauses 1-21.
Clause 33: A device comprising: one or more transceivers; one or more memories; and one or more processors communicatively coupled with the one or more transceivers and the one or more memories, the one or more processors configured to perform the method of any one of Clauses 1-21.
Clause 34: A method at a sensing node of non-linear frequency-modulated (NLFM) radio frequency (RF) sensing, the method comprising: transmitting an orthogonal frequency division multiplexing (OFDM)-based RF sensing signal having a NLFM portion with a frequency-modulated continuous wave (FMCW) portion appended thereto, following the NLFM portion.
Clause 35: A device comprising: one or more transceivers; one or more memories; and one or more processors communicatively coupled with the one or more transceivers and the one or more memories, wherein the one or more transceivers are configured to transmit an orthogonal frequency division multiplexing (OFDM)-based RF sensing signal having a NLFM portion with a frequency-modulated continuous wave (FMCW) portion appended thereto, following the NLFM portion.

What is claimed is:

1. A method at a sensing node of non-linear frequency-modulated (NLFM) radio frequency (RF) sensing, the method comprising:
receiving an NLFM configuration at the sensing node from a configuring node of a wireless network, wherein the NLFM configuration is indicative of a set of one or more parameters of a non-linear function describing time-varying frequency characteristics of an NLFM signal to be used by the sensing node for RF sensing; and
performing an RF sensing function with the sensing node in accordance with the NLFM configuration.

2. The method of claim 1, wherein the set of parameters includes:
an order of Legendre Polynomials (LPs) of the non-linear function, and
a coefficient of the LPs.

3. The method of claim 2, wherein a degree of the LPs is even, and the NLFM signal begins and ends on substantially the same frequency.

4. The method of claim 1, further comprising sending NLFM capability information from the sensing node to the configuring node prior to receiving the NLFM configuration, wherein the NLFM capability information is indicative of:
a maximum order of LPs the sensing node is capable of using,
a maximum frequency ramping speed, or
a combination thereof.

5. The method of claim 1, wherein the sensing node comprises a user equipment (UE) or a base station.

6. The method of claim 1, wherein:
the set of parameters comprises one of a plurality of parameter sets included in the NLFM configuration; and
performing the RF sensing function is based at least in part on a trigger message received from a base station, the trigger message identifying the set of parameters from the plurality of parameter sets.

7. The method of claim 1, wherein the sensing node comprises a transmit (Tx) sensing node, and wherein performing the RF sensing function in accordance with the NLFM configuration comprises transmitting the NLFM signal.

8. The method of claim 7, wherein transmitting the NLFM signal comprises transmitting one or more repetitions of the NLFM signal in a symbol of an orthogonal frequency division multiplexing (OFDM) communication scheme.

9. The method of claim 8, wherein the OFDM communication scheme comprises cyclic prefix (CP)-OFDM in which each OFDM symbol is preceded by a period of time allocated for a CP, and wherein transmitting the one or more repetitions of the NLFM signal in the symbol comprises transmitting the one or more repetitions such that:
there is a first period of time prior to the beginning of the one or more repetitions during which the sensing node makes no transmission, the first period of time comprising the period of time allocated for a CP immediately preceding the symbol; and
there is a second period of time between the end of the symbol and the end of the one or more repetitions during which the sensing node makes no transmission.

10. The method of claim 8, wherein the OFDM communication scheme comprises CP-OFDM in which each OFDM symbol is preceded by a period of time allocated for a CP, and wherein the method further comprises:
appending a first frequency-modulated continuous wave (FMCW) signal to the beginning of the one or more repetitions such that the first FMCW signal is transmitted during the period of time allocated for a CP immediately preceding the symbol, and
appending a second FMCW signal to the end of the one or more repetitions such that the second FMCW signal is transmitted prior to end of the symbol.

11. The method of claim 10, wherein:
there is substantially no frequency jump between the first FMCW signal and the beginning of the one or more repetitions, and
there is substantially no frequency jump between the second FMCW signal and the end of the one or more repetitions.

12. The method of claim 8, wherein transmitting the one or more repetitions of the NLFM signal in the symbol comprises transmitting the one or more repetitions using a plurality of subcarriers.

13. The method of claim 1, wherein the sensing node comprises a receive (Rx) sensing node, and wherein performing the RF sensing function in accordance with the NLFM configuration comprises receiving the NLFM signal.

14. The method of claim 13, further comprising:
detecting, with the sensing node, one or more targets from the received NLFM signal; and
sending a report of the sensing results from the sensing node to the configuring node, the report indicative of the one or more targets.

15. The method of claim 1, wherein performing the RF sensing function in accordance with the NLFM configuration comprises generating a sensing signal for transmission, reception, or both, the sensing signal comprising one or more repetitions, wherein each repetition comprises:
the NLFM signal, and
an FMCW signal appended at the end of the NLFM signal.

16. A method of providing a non-linear frequency-modulated (NLFM) configuration for radio frequency (RF) sensing, the method comprising:
determining, with a configuring node of a wireless network, an NLFM configuration for a sensing node, wherein the NLFM configuration is indicative of a set of one or more parameters of a non-linear function describing time-varying frequency characteristics of an NLFM signal to be used by the sensing node for RF sensing; and
sending the NLFM configuration from the configuring node to the sensing node to enable the sensing node to perform an RF sensing function in accordance with the NLFM configuration.

17. The method of claim 16, wherein the set of parameters includes:
an order of Legendre Polynomials (LPs) of the non-linear function, and
a coefficient of the LPs.

18. The method of claim 16, wherein a degree of the LPs is even, and the NLFM signal begins and ends on substantially the same frequency.

19. The method of claim 16, further comprising receiving NLFM capability information at the configuring node from the sensing node, prior to determining the NLFM configuration, wherein the NLFM capability information is indicative of:
a maximum order of LPs the sensing node is capable of using,
a maximum frequency ramping speed, or
a combination thereof.

20. The method of claim 16, wherein the configuring node comprises a base station or a server of the wireless network.

21. The method of claim 16, wherein the sensing node comprises a transmit (Tx) sensing node, a receive (Rx) sensing node, or both.

22. A sensing node comprising:
one or more transceivers;
one or more memories; and
one or more processors communicatively coupled with the one or more transceivers and the one or more memories, the one or more processors configured to:
receive, via the one or more transceivers, an NLFM configuration at the sensing node from a configuring node of a wireless network, wherein the NLFM configuration is indicative of a set of one or more parameters of a non-linear function describing time-varying frequency characteristics of an NLFM signal to be used by the sensing node for RF sensing; and
perform an RF sensing function with the one or more transceivers in accordance with the NLFM configuration.

23. The sensing node of claim 22, wherein the one or more processors configured to send NLFM capability information from the sensing node to the configuring node prior to receiving the NLFM configuration, and wherein the one or more processors configured to include, in the NLFM capability information, information indicative of:
a maximum order of LPs the sensing node is capable of using,
a maximum frequency ramping speed, or
a combination thereof.

24. The sensing node of claim 22, wherein the one or more processors are configured to perform the RF sensing function is based at least in part on a trigger message received from a base station, the trigger message identifying the set of parameters from a plurality of parameter sets included in the NLFM configuration.

25. The sensing node of claim 22, wherein the sensing node comprises a transmit (Tx) sensing node, and wherein, to perform the RF sensing function in accordance with the NLFM configuration, the one or more processors are configured to transmit the NLFM signal via the one or more transceivers.

26. The sensing node of claim 25, to transmit the NLFM signal, the one or more processors are configured to transmit one or more repetitions of the NLFM signal in a symbol of an orthogonal frequency division multiplexing (OFDM) communication scheme.

27. The sensing node of claim 22, wherein, to perform the RF sensing function in accordance with the NLFM configuration, the one or more processors are configured to generate a sensing signal for transmission, reception, or both, such that the sensing signal comprises one or more repetitions, and each repetition comprises:
the NLFM signal, and
an FMCW signal appended at the end of the NLFM signal.

28. A configuring node for providing a non-linear frequency-modulated (NLFM) configuration for radio frequency (RF) sensing, the configuring node comprising:
one or more transceivers;
one or more memories; and
one or more processors communicatively coupled with the one or more transceivers and the one or more memories, the one or more processors configured to:
determine an NLFM configuration for a sensing node, wherein the NLFM configuration is indicative of a set of one or more parameters of a non-linear function describing time-varying frequency characteristics of an NLFM signal to be used by the sensing node for RF sensing; and
send the NLFM configuration via the one or more transceivers to the sensing node to enable the sensing node to perform an RF sensing function in accordance with the NLFM configuration.

29. The configuring node of claim 28, wherein the one or more processors are configured to receive NLFM capability information from the sensing node prior to determining the NLFM configuration, wherein the NLFM capability information is indicative of:
a maximum order of LPs the sensing node is capable of using,
a maximum frequency ramping speed, or
a combination thereof.

30. The configuring node of claim 28, wherein the configuring node comprises a base station or a server of the wireless network.
